(19) United States
(12) Patent Application Publication
(10) Pub. No.: US 2007/0067735 A1
(43) Pub. Date: Mar. 22, 2007

(54) Graphical user interface

(75) Inventors: Keith P. Hawley, Jacksonville, FL (US); James R. Hawley, Jacksonville, FL (US); Colleen M. Tiner, Jacksonville, FL (US); Wendy M. Flask, Jacksonville, FL (US); Linda K. Corrao, Friant, CA (US); Matthias J. Liebgott, Naperville, IL (US); Kevin McDonald, Jacksonville, FL (US); Adrienne Lee Moore, Jacksonville, FL (US); Dana Giovenco, Matthews, NC (US); Patrick Flaherty, Jacksonville, FL (US); Weston A. Burk, Jacksonville, FL (US)

Correspondence Address: JENKENS & GILCHRIST, P.C., 225 WEST WASHINGTON, SUITE 2600, CHICAGO, IL, 60606, US

(73) Assignee: Kemper Independence Insurance Company

(21) Appl. No.: 11/521,863

(22) Filed: Sep. 15, 2006

Related U.S. Application Data
(60) Provisional application No. 60/717,777, filed on Sep. 16, 2005.

(51) Int. Cl. G06F 17/00

(52) U.S. Cl. 715/792

(57) ABSTRACT

A graphical user interface includes a main screen adapted to display a graphical output from a processor and data input fields adapted to receive data. The graphical user interface also includes at least one expandable tile, the expandable tile having a closed state and an open state. The expandable tile causes display data and data input fields obscured by the expandable tile in the closed state to be revealed to a user when the expandable tile is placed in its open state.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

1. Field of the Invention

The present invention relates generally to graphical user interfaces, and more particularly, to graphical user interfaces for remotely located insurance agents or other designated users.

2. Background of the Invention

In many conventional insurance underwriting systems, insurance underwriters provide proprietary policy service applications to customer service representatives or agents in the field. These agent interact with the customers, prospective insurance applicants, and provide quotes for various insurance policies.

Current proprietary policy service applications typically comprise a plurality of windows through which the agent or user is passed. These applications tend to be navigation intensive and cumbersome, which exacerbates existing problems in the processing of insurance quotes, including the time-consuming task of data entry. It would be beneficial, therefore, to improve the efficiency of the agents' ability to process quotes, issue policies, and update policies. Efficiency gains would permit the agents more time with which to pursue additional business opportunities. Further, superior graphical interfaces may, even without correspondingly efficiency gains, still be viewed as providing a less stressful interaction and/or more fluid interface with the underlying application. Thus, improvements in the graphical user interface between proprietary policy service applications and the agent and user, which may include the end user or customer, could ultimately influence such agent's or user's decision as to which proprietary policy service application and, correspondingly, which insurance underwriter they prefer.

### SUMMARY OF THE INVENTION

In accord with one aspect of the present concepts, a graphical user interface is provided which includes a main screen adapted to display a graphical output from a processor and data input fields adapted to receive data. The graphical user interface also includes at least one expandable tile, the expandable tile having a closed state and an open state. The expandable tile causes display data and data input fields obscured by the expandable tile in the closed state to be revealed to a user when the expandable tile is placed in its open state.

In accord with one aspect of the present concepts a method for processing an insurance transaction is provided which includes the act of providing, for a first computer having a display, a main screen comprising a plurality of links to a corresponding plurality of expandable tiles required to process an insurance transaction for a specified risk. Each of the expandable tiles comprises a plurality of required data entry fields requiring input of data therein to process the insurance transaction. The method also includes the act of activating the plurality of links to access associated ones of the expandable tiles to permit data entry into respective ones of the required data entry fields. The method further includes the acts of inputting data corresponding to the required data entry fields required to process the insurance transaction in each of the plurality of expandable tiles and determining an insurance premium for the risk in view of the input data.

In accord with another aspect of the present concepts a computer-readable medium bearing instructions for processing an insurance transaction, the instructions arranged, when executed by one or more processors, to cause the one or more processors to perform acts in accord with the above-noted method.

In accord with yet another aspect of the present concepts, an apparatus for processing an insurance transaction is provided which comprises a first computer having a display and a communication interface connected to the first computer. The first computer comprises an insurance application provided with instructions for processing an insurance transaction in accord with the above-noted method.

The above summary of the present invention is not intended to represent each embodiment, or every aspect, of the present invention. This is the purpose of the Figures and the detailed description which follow.

### BRIEF DESCRIPTION OF THE DRAWINGS

The foregoing and other advantages of the invention will become apparent upon reading the following detailed description and upon reference to the drawings.

FIGS. 1(a)-(h) show examples of screen-shots of a first aspect of a conventional graphical user interface.

FIGS. 2(a)-(d) show examples of screen-shots of a second aspect of a conventional graphical user interface.

FIGS. 3(a)-(d) show examples of screen-shots of a third aspect of a conventional graphical user interface.

FIGS. 4(a)-(e) show examples of screen-shots of a fourth aspect of a conventional graphical user interface.

FIG. 5 shows an example of a screen-shot of a fifth aspect of a conventional graphical user interface.

FIGS. 6(a)-(e) show representations of screen-shots for at least some aspects of the present concepts.

FIGS. 7(a)-(l) show examples of screen-shots illustrating at least some aspects of the present concepts.

FIGS. 8(a)-(d) show examples of screen-shots illustrating a change to a policy in accord with at least some aspects of the present concepts.

FIG. 9 shows one example of hardware upon which the present concepts may be implemented.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

The present concepts relates to a server-client (e.g., internet-based) software application that allows insurance agents, other designated users, and/or customers to use remote or portable computers to quote new business, issue policies, quote policy changes and process policy updates related to those quoted policy changes.

The present concepts may be, in at least some embodiments, comprises a plurality of phases. It is initially noted that the delineation between the phases presented below is neither required intrinsically nor required in a user interface.

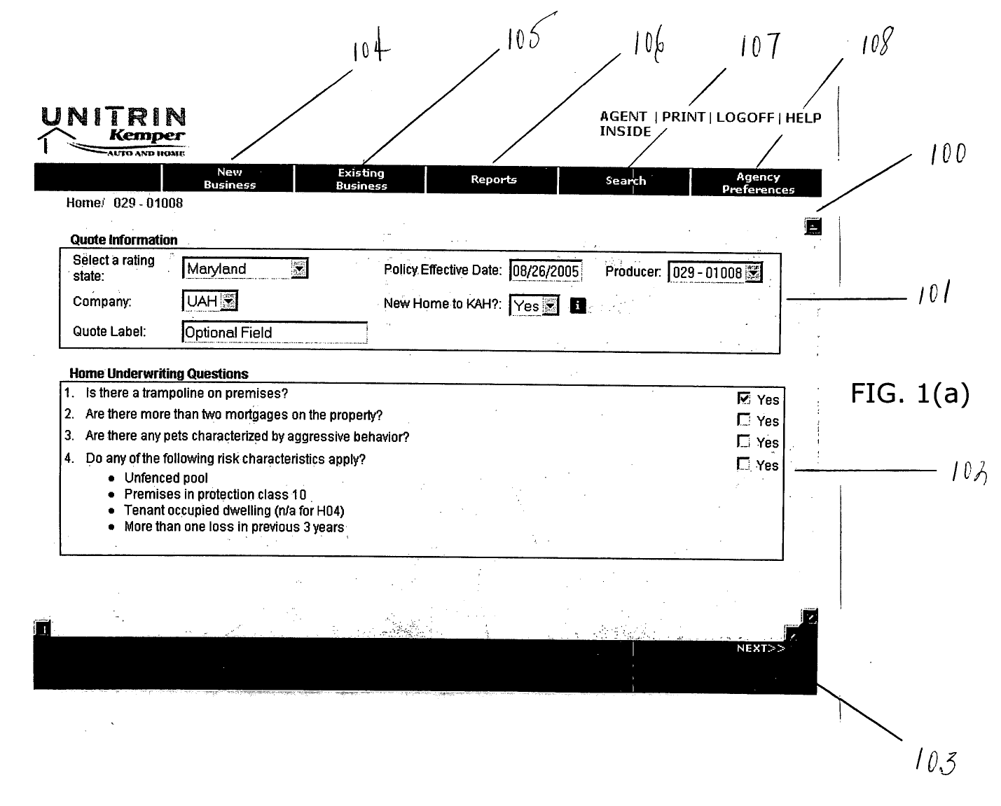

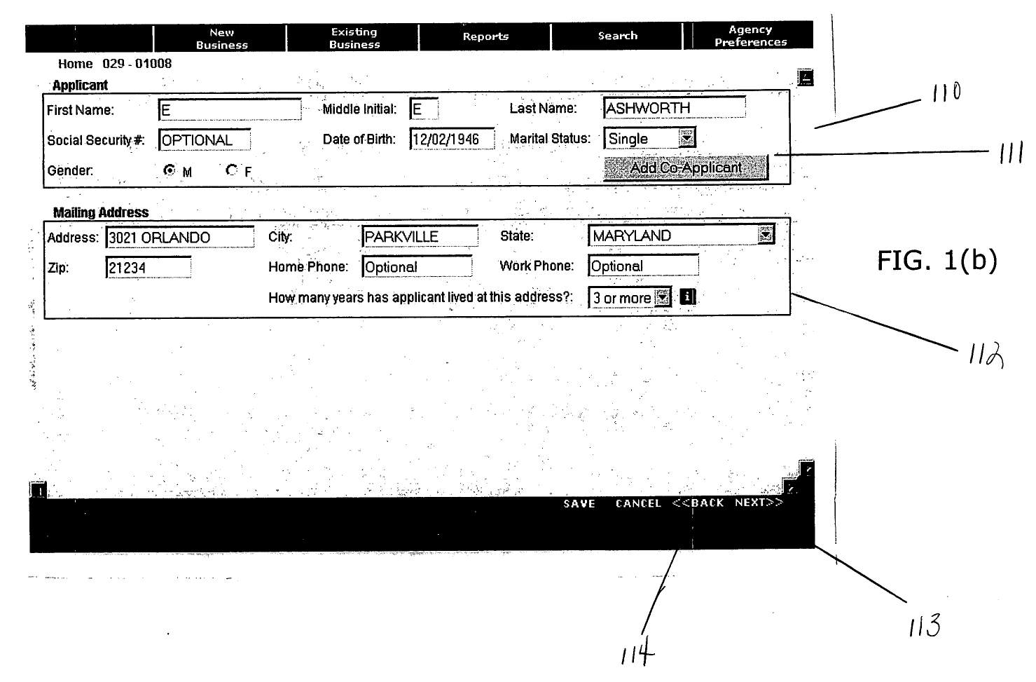

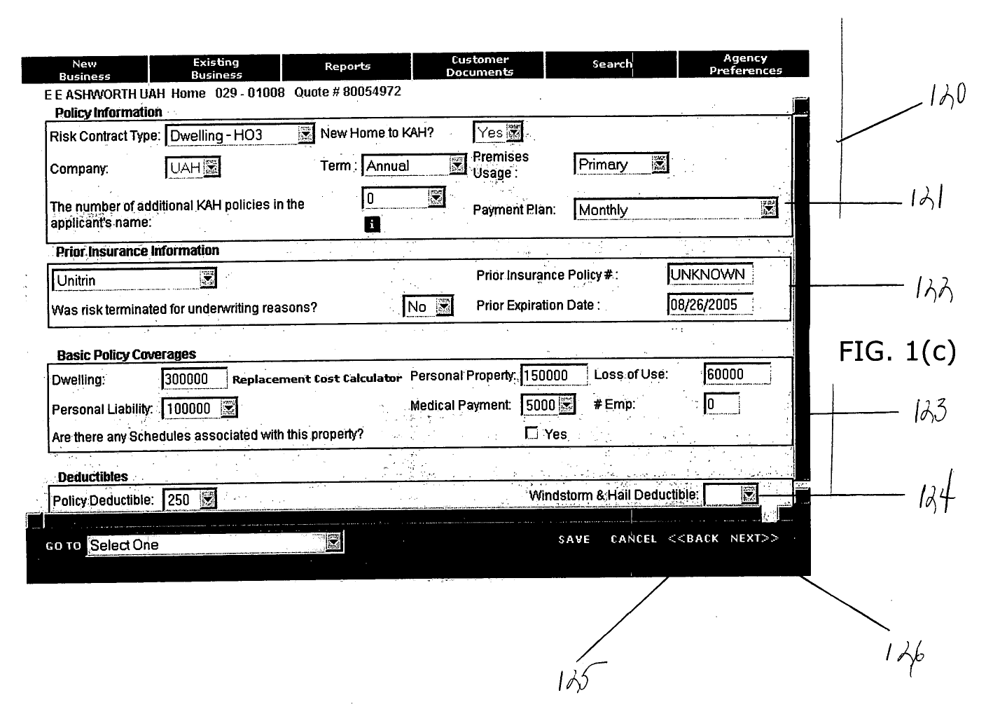

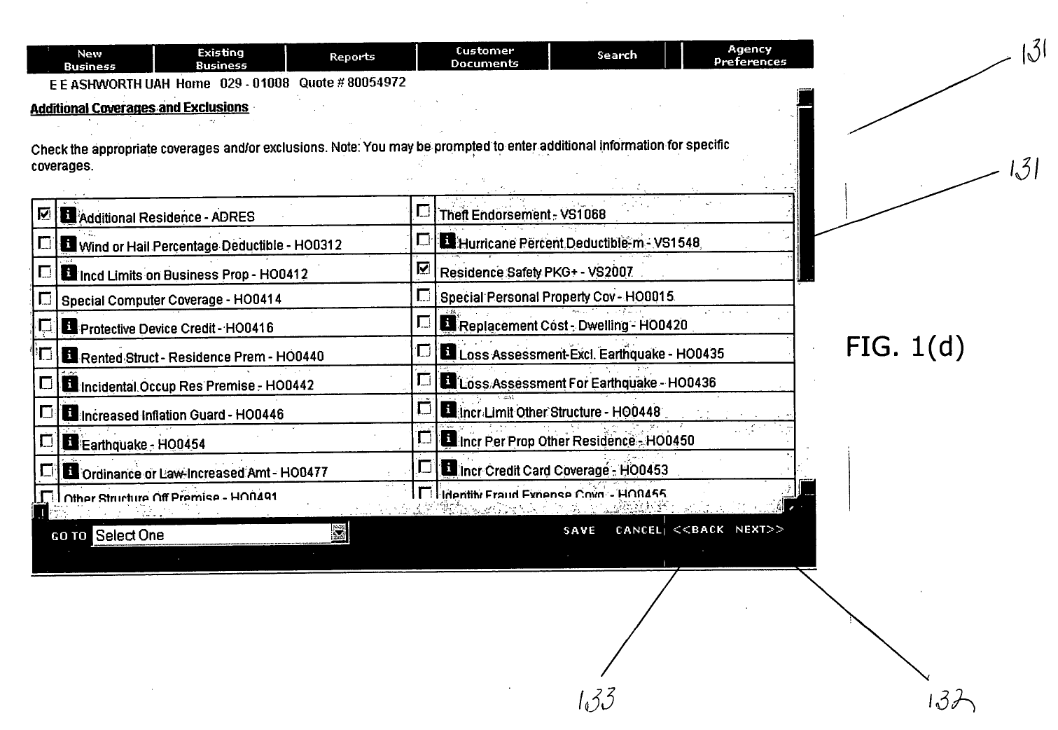

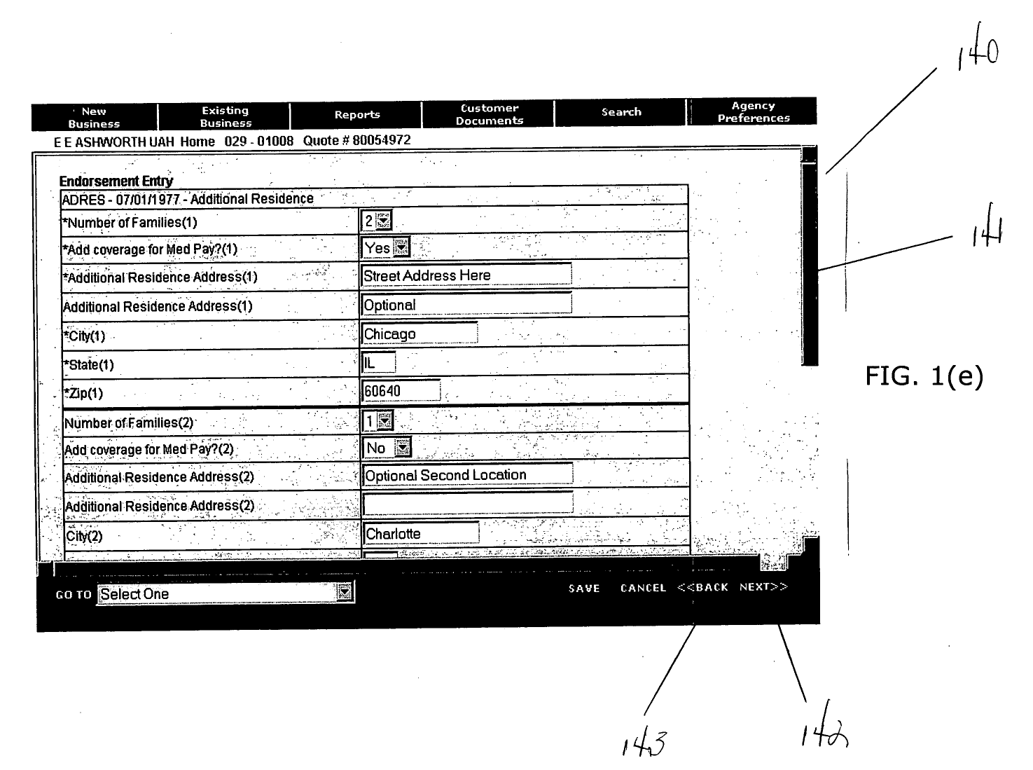

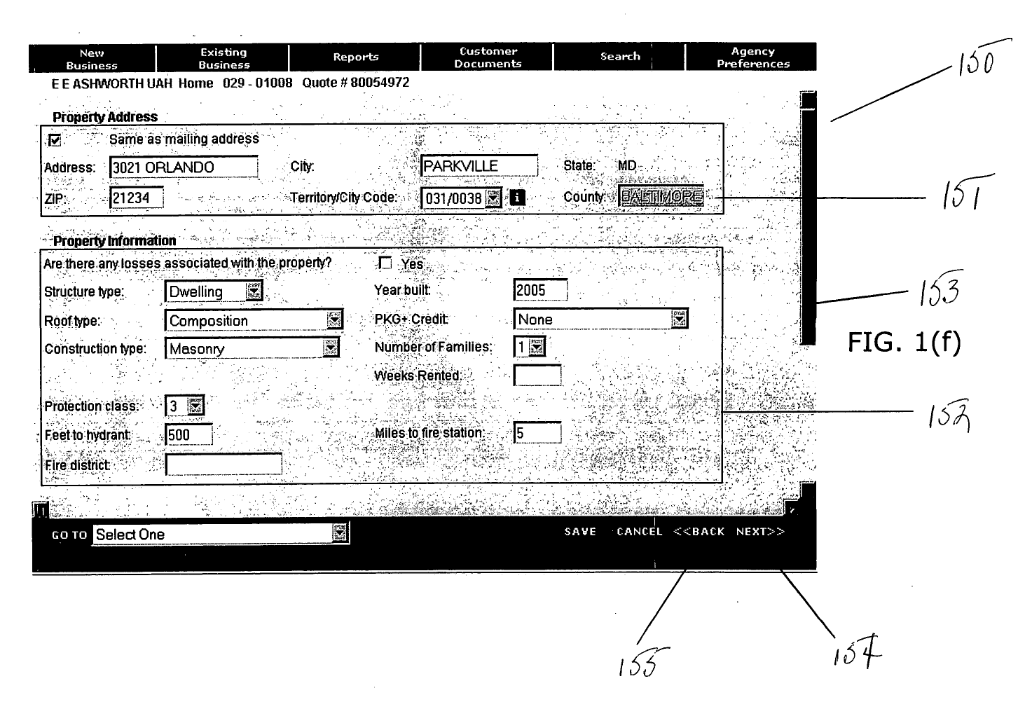

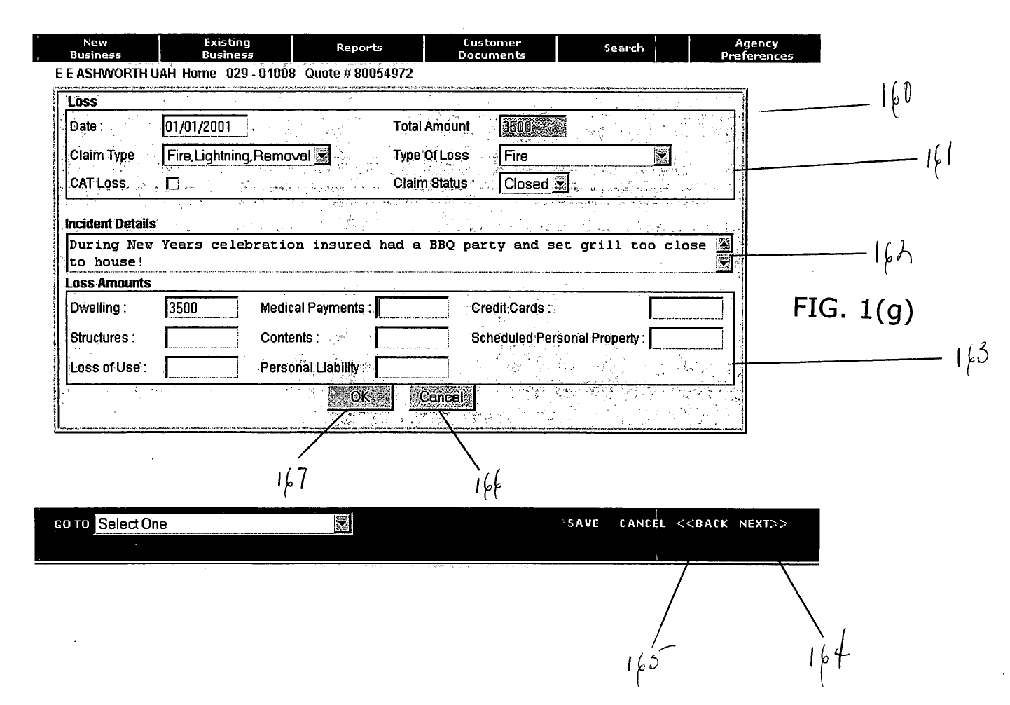

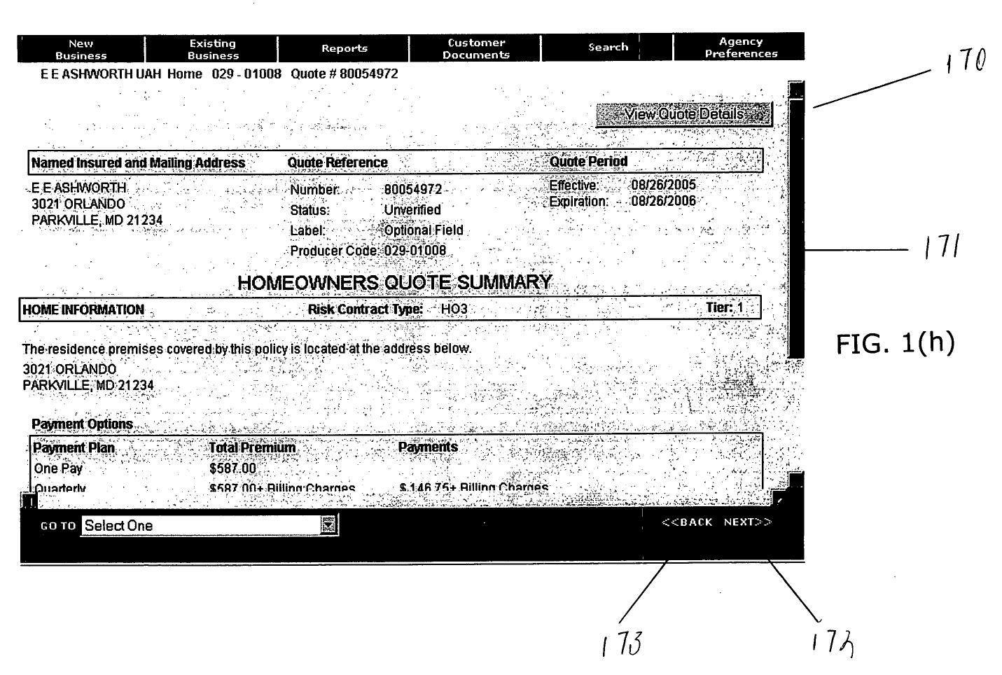

In the current application, Phase 1 of the present concepts represents a minimum amount of data entry that is required to accurately rate a new business quote. In Phase 1 the insurance agent (or other user) will complete, in this example, a maximum of 7 screens, represented in FIGS. 1(a)-(h). In the following example, the screenshot examples relate to data entry relating to a quote for new home insurance.

FIG. 1(a) shows a main screen 100 having a “Quote Information” portion 101 displaying fields for entry of general quote information and a “Home Underwriting Questions” portion 102 having home underwriting questions. The main screen 100 generally presents questions that, if answered affirmatively, identifies undesired risks at the earliest possible time and prevents the agent (or other user) from proceeding with the quote. Hereinafter and herein, the term agent is generically used to refer to any user, which may include for example an agent, a user, an insured, and even a prospective customer.

Turning first to the “Quote Information” portion 101, a “Rating State” field is providing for entry of the rating state (e.g., “Maryland”) of the prospective or current client (hereinafter “client”). A “Company” field is provided to enter the underwriter for the policy (e.g., “UAH” for Unitrin Auto and Home). A “Policy Effective Date” field is provided for entry of the policy effective date (e.g., “Aug. 26, 2005”) and a “Producer” field is provided for entry of a reference number relating to the producer or insurance agent (e.g., “029-01008”). A “New Home to KAH” field is also provided for entering whether the home for which the quote is to be provided is a new home to Kemper Auto and Home (i.e., the underwriter or to the company issuing the policy) or an existing home already having a policy. Adjacent to the “New Home to KAH” field is an information tag, represented by a black square with a white letter “i” disposed therein. A “Quote label” field is also provided for entry of an optional descriptive label for the quote.

In the “Home Underwriting Questions” portion 102 of the main screen 100, four numbered questions are provided with associated underwriting questions. The first question asks whether a trampoline is on the premises and the associated data entry field is checked “Yes” in this example. The subsequent fields require data entry, if applicable, if there are more than two mortgages on the property, if there are any pets characterized by aggressive behavior, or whether any other conventional impediments to underwriting are present. Such conventional impediments can include, as shown, an unfenced pool, premises in protection class 10, a tenant occupied dwelling (which may have exceptions), and/or a loss claimed in the previous 3 years.

At the bottom of the main screen 100 is provided a “Next” button 103 which permits the user to move to the next data entry screen, shown in FIG. 1(b). The user may be permitted to utilize such button at will or, optionally, once all of the requisite data has been entered into the main screen.

At the top of the main screen 100 is a drop-down menu 109 having selections available for “New Business” 104, “Existing Business” 105, “Reports” 106, “Search” 107, and “Agency Preferences” 108, each of which present separate options relating to the associated heading. Under the “New Business” 104 drop-down menu, the producer may select from a variety of new business options appropriate for the insurance agency potentially underwriting the policy for a new applicant. For example, the potential new policies could include those in auto, home, auto and home, umbrellas, home business, and schedule personal property. The menu items for the umbrellas, home business, and schedule personal property may not be separately listed in the drop-down menus because they are endorsed to an underlying main policy. Another drop down may, for example, include convert to package, wherein a customer may combine an auto and home policy into one packaged policy to save money.

The drop-down menu for “Existing Business” 105 permits producers/agents to make policy changes on an existing policy through a “Quote/Endorse/Submit” option. As one example of this particular field, if an insured is shopping for a new vehicle the agent can quote a price. If the customer then purchases that vehicle, that previously saved quote can be retrieved and the policy updated. A “Quick Update” option may also be provided for common policy change transactions (e.g., Mortgagee changes) that do not have a rating impact. A “PLIS Entry/View” feature, “PLIS” being a “Personal Lines Interface System,” is the Kemper mainframe or central system that is code driven. Some transactions are not supported in the application described in FIGS. 1(a)-5 herein and are supported in PLIS. Therefore, PLIS access is granted to agents to complete those types of transactions. The “PLIS Entry/View” feature may thus be provided to access a corporate mainframe system, hub, server, or the like, to facilitate the uploading and downloading of information to facilitate the applications noted herein to, for example, provide definitions of coded entries. The drop down menu for “Reports” 106 permits agents to order a “CLUE/IBS/MVR Report” without creating a quote. Sometimes, an agent may have suspicion that a customer may not be confessing to all losses or perhaps a customer simply does not remember a loss date. In this case, the agent can order the report and then create a quote. In one aspect, the application noted herein will be configured to transfer all report findings in such CLUE/IBS/MVR reports to that quote. Agents can also retrieve statistics on how many quotes they have created versus how many policy they have issued from those quotes (Hit Ratio). If a Home Value report is needed to determine replacement cost of a dwelling then the agents may be provided the option to order this report without creating a quote.

The “Search” 107 drop-down menu option permits an agent to search for, for example, a quote, an ordered report, or an issued policy. The “Agency Preferences” 108 drop-down menu option provides agents with the ability to create a template quote. Perhaps an agent has decided that the basic $100,000 liability coverage offered by an insurer on a home risk is not sufficient and they tend to recommend to all of their customers that they increase this liability to $300,000. They can choose to default this field value to $300,000 on a quote instead of the $100,000 to eliminate choosing this selection each time a quote is created. Although not shown in FIG. 1(a), a “Customer Documents” field may be provided to permit agents to print customer documents such as insurance binders that might be needed to bring to a house closing, applications that require signature, CLUE Reports, state-specific required signature forms, and supplemental applications, and auto ID Cards.

FIG. 1(b) shows an “Applicant” screen 110 comprising an “Applicant” portion 111 in which an applicant's personal information is listed and a “Mailing Address” portion 112 in which the applicant's mailing address and other contact information is entered. Turning first to the “Applicant” portion 111, fields are provided for entry of the applicant's first name, middle initial, last name, social security number, date of birth, gender, and marital status. A button is also provided labeled “Add Co-Applicant” which would guide the user to another data-entry screen in which data entry fields similar to that as presented in the “Applicant” portion 111 would be displayed. The “Mailing Address” portion 112 of the applicant screen 110 includes fields for entry of the applicant's mailing address and, optionally, contact information such as home phone number and work phone number. Another field relating to years of residency is provided an inquires “How many years has applicant lived at this address?” with a pull-down data entry field in which “3 or more” is displayed. Adjacent to the field is an information tag, represented by a black square with a white letter “i” disposed therein.

Once the above data has been input, sufficient information exists to electronically order an IBS (Insurance Bureau Score) in most states from ChoicePoint (a national credit reporting agency) to assist in the determination of an appropriate pricing strategy. Thus, an IBS is typically, but not necessarily, ordered at this stage.

As with the main screen 100, the “Applicant” screen 110 is provided a “Next” button 113 which permits the user to move to the next data entry screen, shown in FIG. 1(c), once all of the requisite data has been entered into the main screen. The applicant screen 110 is also provided a “Back” button 114 which permits the user to move back to the previous data entry screen, shown in FIG. 1(a).

For convenience, some of the relevant data entered may be persistently displayed on a portion of the screen. As shown, the text “Home 029-01008” is displayed toward a top of the applicant screen 110, referencing the type of policy and the producer number.

FIG. 1(c) shows a “Coverages” screen 120 comprising a “Policy Information” portion 121, a “Prior Insurance Information” portion 122, a “Basic Policy Coverages” portion 123, and a “Deductibles” portion 124. As noted above, some of the relevant data entered may be persistently displayed on a portion of the screen. FIG. 1(c) shows the text “E E Ashworth UAH Home 029-01008 Quote #80054972” displayed toward a top of screen 110, respectively referencing applicant, underwriter, type of policy, producer number, and quote number. Similarly, the coverage screen 120 is provided a “Next” button 125 which permits the user to move to the next data entry screen, shown in FIG. 1(d), once all of the requisite data has been entered into the main screen. The applicant screen 110 is also provided a “Back” button 114 which permits the user to move back to the previous data entry screen, shown in FIG. 1(a).

In the “Coverages” screen's 120 “Policy Information” portion 121, a “Risk Contract Type” data entry field having a pull-down data selection wherein “Dwelling—HO3” is indicated. Two fields from the main screen 100 are repeated in the “Policy Information” portion 121, the “Company” field and the “New Home to KAH” field, both of which reflect the data that was previously entered. Additional fields are provided for the “Term” data entry field, which has a pull-down data selection indicating that an “Annual” term was selected and a “Premises Usage” field, which shows that a “Primary” term was selected from a pull-down data selection field. Another field labeled “The number of additional KAH policies in the applicant's name” is provided with a pull-down data selection and an information tag. In the present example, the number “0” is indicated. Lastly, a “Payment Plan” field is provided with a pull-down data selection field, wherein a “Monthly” payment plan is indicated.

The “Prior Insurance Information” portion 122 includes a pull-down data selection fields for the prior insurer, here “Unitrin,” and for a data field labeled “Was risk terminated for underwriting reasons?” Data entry fields are also provided for the “Prior Insurance Policy #” and for the “Prior Expiration Date”.

The “Basic Policy Coverages” portion 123 includes a “Dwelling” data entry field in which “300,000” was entered, a “Personal Property” field in which “150,000” was entered, and a “Loss of Use” field in which “60,000” was entered. Adjacent the “Dwelling” field is a “Replacement Cost Calculator,” which would take the producer or user to another screen to calculate the replacement cost. This hyperlink would permit the agent to order a “Home Value” report by, for example, directing the agent on-line to a valuation vendor (e.g., Home Value) to create a replacement cost estimation report which would help the agent determine how much insurance should be written. Data from such report could optionally be electronically transferred into the quote. Pull-down data selection fields are provided for the fields of “Personal Liability” and “Medical Payment,” for which fields “100,000” and “5000” have been selected, respectively. A “# Emp” field, showing zero employees in this example, is provided for any potential live-in employees on the premises. Another field labeled “Are there any Schedules associated with this property?” with a box that may be checked yes, if applicable.

Finally, the coverage screen's 120 “Deductibles” portion 124 includes a pull-down data selection field for the “Policy Deductible” which includes conventional policy deductible levels (e.g., $100, $250, $500, $1000, etc.). Another pull-down data selection field is provided for the “Windstorm & Hail Deductible”.

FIG. 1(d) shows an “Additional Coverages (endorsements)” screen 130 displaying numerous “Additional Coverages and Exclusions” which permits the producer to select, a la carte, from among numerous possible conventional coverages and exclusions. These conventional coverages and exclusions include, but are not limited to fields for “Additional Residences—ADRES,” “Wind or Hail Percentage Deductible—HO0312,” “Incd Limits on Business Prop—HO0412,” and “Special Computer Coverage—H0414,” as presented in the left column. The first three of these four noted data entry fields each include an information tag, which may be accessed, such as by single-clicking or double-clicking thereupon, to reveal additional information related to the field to which the information tag is associated. A sliding navigation bar 131 is provided to permit the user to move up and down through the columns of fields presented. The “Coverages” screen 130 is provided a “Next” button 132 which permits the user to move to the next data entry screen, shown in FIG. 1(e) and a “Back” button 133 permits the user to move back to the previous data entry screen, shown in FIG. 1(c). In this screen 130, the fields for “Additional Residences—ADRES” and “Residence Safety PKG+—VS2007” are shown to be affirmatively checked.

FIG. 1(e) shows an “Additional Coverages (continued)” screen 140. In this screen, a first endorsement entry is shown for “ADRES—Sep. 01, 1977—Additional Residence,” corresponding to the entry in the previous screen (FIG. 1(d)) in which “Additional Residences—ADRES” was checked. FIG. 1(e) shows, for this particular endorsement entry, mandatory data fields for “Number of Families(1),” “Add Coverage for Med Pay?,” “Additional Residence Address(1),” “City(1),” “State(1),” and “Zip(1)”. A sliding navigation bar 141 is provided to permit the user to move up and down through the entirety of the endorsement entries. A “Next” button 142 permits the user to move to the next data entry screen, shown in FIG. 1(f) and a “Back” button 143 permits the user to move back to the previous data entry screen, FIG. 1(d).

FIG. 1(f) shows a Property Information screen 150 including a “Property Address” portion 151 and a “Property Information” portion 152. In the “Property Address” portion 151, the box labeled “Same as mailing address” is shown to be checked and, correspondingly, the data entered in the FIG. 1(b) “Address,” “City,” “State,” and “ZIP” fields are duplicated therein. A new field “Territory/City Code” is also provided with a pull-down data selection field, indicating “031/0038,” and an information tag. A “County” field indicates that the address corresponds to “Baltimore” county.

The “Property Information” portion 152 of FIG. 1(f) shows, as a preliminary field, a field inquiring “Are there any losses associated with the property?” with a corresponding box which may be checked “Yes,” if applicable. Successive data entry fields are provided for the “Structure Type,” “Roof Type,” “Construction Type,” and “Protection Class,” for which “2005”, “Dwelling,” “Composition,” “Masonry,” and “3” were respectively entered. Each of the fields are provided with a pull-down data selection field, each of which provides commonly entered responses for the respective fields (e.g., protection class from 1 (good) to 10 (bad)). One data entry field is provided for “Year built.” Additional data entry fields are provided for entry of “Feet to hydrant”, “Fire District,” and “Miles to fire station”. A data entry field “PKG+Credit” is also provided with a pull-down data selection field. This data entry field would permit, for example, a producer to provide a package credit if the applicant is a current client of the insurance company and subscribes to other offerings. For example, an applicant already having an automobile policy might be given a package discount for a home policy quote. A sliding navigation bar 153 is provided to permit the user to move up and down through the “Property Information”. A “Next” button 154 permits the user to move to the next data entry screen, shown in FIG. 1(g) and a “Back” button 155 permits the user to move back to the previous data entry screen, FIG. 1(e).

FIG. 1(g) is an optional data entry screen that permits entry of information relating to reported incidents or losses. FIG. 1(g) includes a “Loss” portion 161, an “Incident Details” portion 162, and a “Loss Amounts” portion 163. The “Loss” portion 161 includes data entry fields for the “Date” of the loss, the “Claim Type,” the “Type of Loss”, and the “Claim Status”. The “Claim Type,” the “Type of Loss”, and the “Claim Status” each include pull-down data selection fields reflecting conventional claim entries for the respective fields. In the example provided, a claim was made for “Fire, Lightning, Removal” for which the loss was “Fire” and the claim status was “Closed.” A box labeled “CAT Loss” is also provided which may be checked if the loss was a catastrophic loss (IS THIS CORRECT?). In the “Incident Details” portion 162, text may be entered reflecting the actual details of the claimed loss. In this example, text is entered that “During New Years Celebration insured had a BBQ party and set grill too close to house!”. In the “Loss Amounts” portion 163, data fields for “Dwelling,” “Structures,” “Loss of Use,” “Medical Payments,” “Contents,” “Personal Liability,” “Credit Cards,” and “Scheduled Personal Property” are provided. Buttons 166, 167 are provided for the producer to either cancel the loss data entry or confirm the entered data, respectively.

In FIG. 1(g), a “Next” button 164 permits the user to move to the next data entry screen, shown in FIG. 1(h) and a “Back” button 165 permits the user to move back to the previous data entry screen, FIG. 1(f).

FIG. 1(h) provides a “Quote Summary” screen 170. Similar to the previous screens, a sliding navigation bar 171, a “Next” button 172 and a “Back” button 173 are provided. In the top portion of the “Quote Summary” screen 170 are information on the named insured and mailing address, quote reference, and quote period. From the data displayed in the preceding screens (e.g., FIGS. 1(a)-(g)), the quote period is shown to be for an annual policy. The producer code “029-01008” is also carried forward. A quote number, “80054972,” is provided on the basis of the unverified quote. A “Homeowners Quote Summary” is provided in a middle portion of the “Quote Summary” screen 170 and displays the “Risk Contract Type” (e.g., “HO3”) and “Tier” (e.g., “1”) for the property covered, here a residence, at the listed address. Lastly, toward a bottom portion of the “Quote Summary” screen 170, is listed the “Payment Options”. Displayed for the annual policy are options of a single payment (e.g., “One Pay”) or a “Quarterly” payment which indicates separate additional “Billing Charges”.

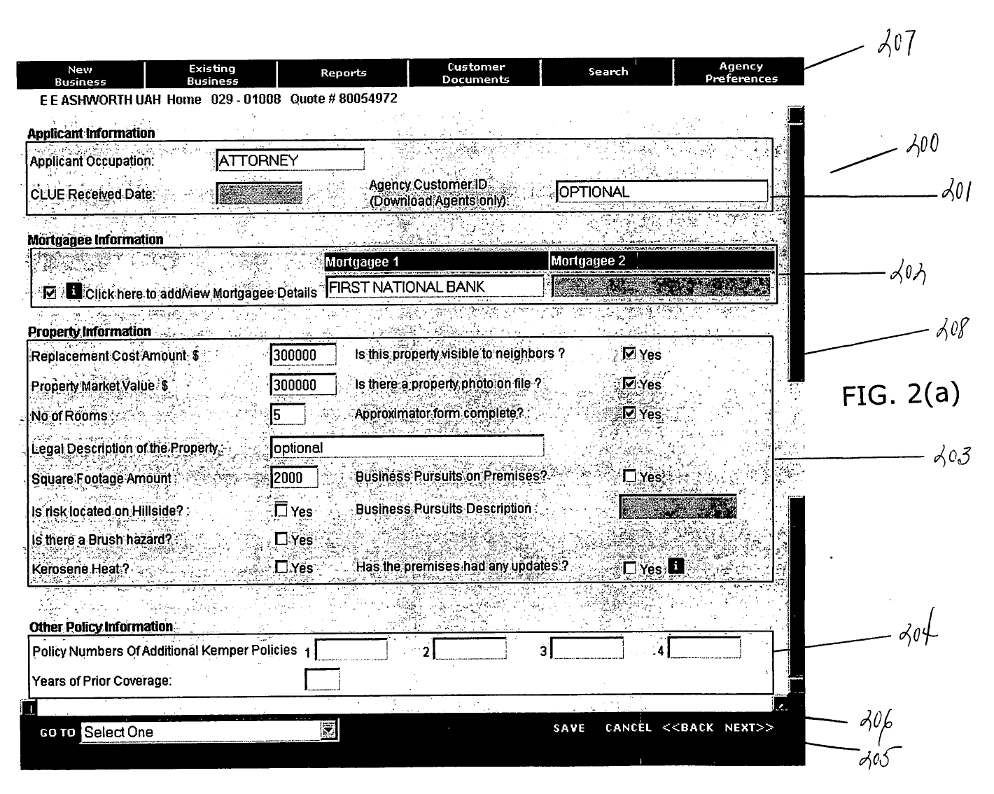

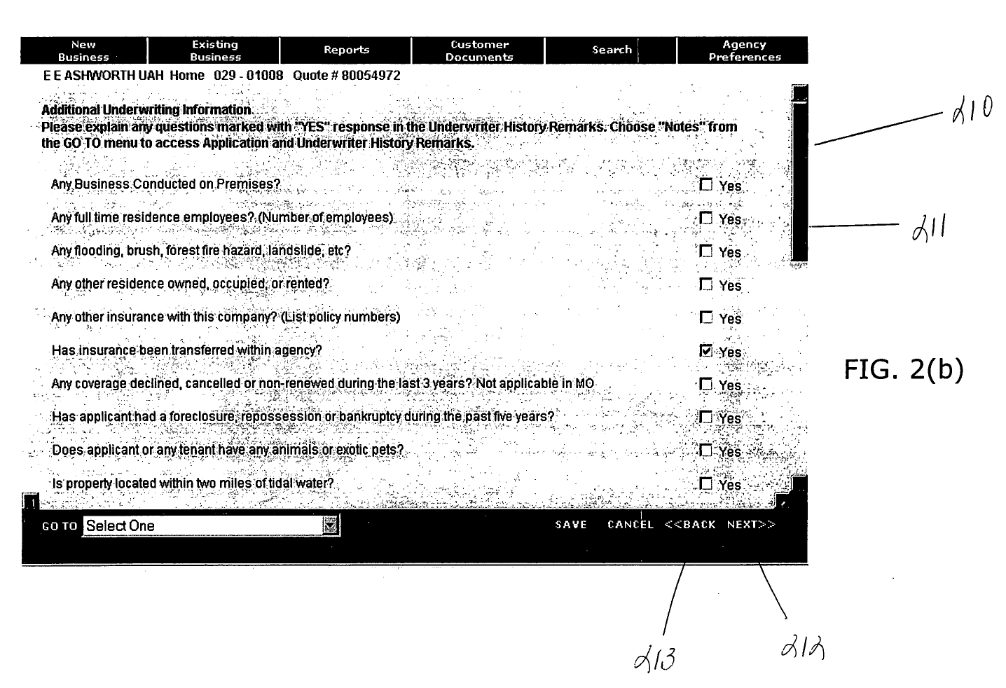

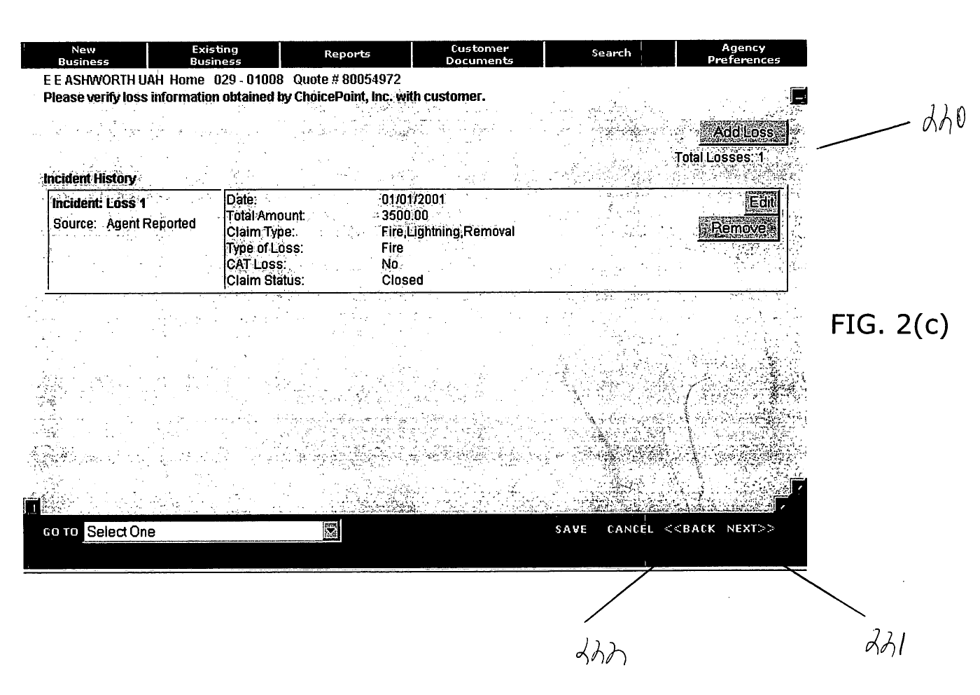

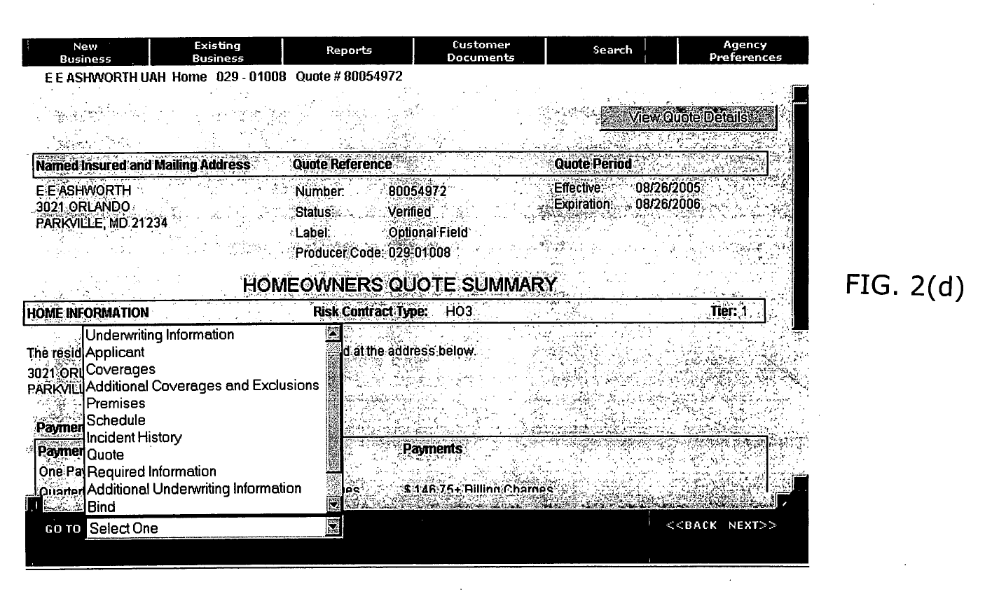

In FIG. 1(h), the agent receives the Quote Summary which is a preliminary quote based on the input information. Losses and incorrect data may always affect the preliminary quote. In the subsequent phase, shown in FIGS. 2(a)-(d), a CLUE report is ordered from a national reporting agency (e.g., ChoicePoint) to determine if all claimed losses were accurately reported by the applicant.

FIGS. 2(a)-(d) relate to non-rated fields that are required for policy issuance. Whereas the fields and screens presented in FIGS. 1(a)-(h) provided for the entry of sufficient information to permit issuance of a quick price quote, such information is not sufficient to issue a policy. FIGS. 2(a)-(d) thus cover situations where the applicant has been provided with and has accepted a policy quote and has elected to proceed with the issuance of a policy. At this time, the agent will order, or the software package itself will order, a CLUE report from a national reporting agency (e.g., ChoicePoint). If any additional losses are reported that were not reported in the phase covered by FIGS. 1(a)-(h), it could increase the quoted price.

FIG. 2(a) shows a non-rated “Property Information” screen 200 comprising an “Applicant Information” portion 201, “Mortgagee Information” 202, “Property Information” 203, and “Other Policy Information” 204. The “Applicant Information” portion 201 includes, in this example, a field for entry of the Applicant's occupation, as well as fields for the CLUE receipt date and an optional field for the Agency Customer ID. The “Mortgagee Information” portion 202 includes data entry fields for a “Mortgagee 1” and a “Mortgagee 2,” if the property is subject to one or two mortgages, respectively, with an information tag permitting the agent to click thereupon to view, edit, and/or add mortgagee details.

FIG. 2(a) also shows, in the “Property Information” portion 203, detailed information on the property including data entry fields for “Replacement Cost Amount $,” “Property Market Value $,” “No. of Rooms,”, “Legal Description of Property,” and “Square Footage Amount” for which the values of “300000,” “300000,” “5,” “optional,” and “2000” were input in the present example. Additional boxes are provided for the agent to enter a check or affirmative mark if, for example, the property is located on a hillside, presents a brush hazard, uses kerosene heating, visible to neighbors, etcetera. Also, boxes are provided for the agent to enter whether or not a photo of the property is on file, whether an approximator form was completed, whether there are business pursuits on the premises and a description thereof, if applicable, and whether the premises has had any updates. An information tag is provided adjacent the latter data entry box to permit the agent to access and/or enter additional data relating to updates.

In the “Other Policy Information” portion 204, data entry fields are provided for the policy numbers of additional policies held by the applicant, if applicable, and the years of the prior coverage.

A drop-down menu 209 is provided and contains functions described above with respect to drop-down menu 109 in FIG. 1(a). Additional navigation tools include a sliding navigation bar 208 to permit the user to move up and down through the entirety of the property information. A “Next” button 205 permits the user to move to the next data entry screen, shown in FIG. 2(b) and a “Back” button 206 permits the user to move back to the previous data entry screen, FIG. 1(h).

FIG. 2(b) presents the agent with a screen 210 comprising typical underwriting questions. In FIG. 2(b), the agent is instructed to explain any questions marked with a “Yes” response and to choose “Notes” from the “Go To” Menu to access Application and Underwriter History Remarks. As with previous screens, additional navigation tools include a sliding navigation bar 211, a “Next” button 212, and a “Back” button 213. The underwriting questions include, but are certainly not limited to, whether or not any business is conducted on the premises; whether or not there are any full time residence employees; whether or not there is any flooding, brush, forest fire hazards, landslide hazards, etc.; whether the premises is owner occupied; whether or not any coverage was declined, cancelled, or non-renewed within the previous 3 years; whether or not the applicant or tenant has any animals or exotic pets; whether or not the property is located within two miles of tidal water, etc.

FIG. 2(c) shows an “Incident History” screen 220 if CLUE shows a reported loss. This example reflects the agent-reported loss noted above with respect to FIG. 1(g) and, in this instance, confirms that the losses noted in the quote were accurately reported. Navigation tools include a “Next” button 221 and a “Back” button 222.

FIG. 2(d) shows the final “Quote Summary” which may display “Verified” or a like indicator indicating that the CLUE report has been received and all of the input data independently validated. In this case, one difference between the screen of FIG. 2(d) and that of FIG. 1(g) is that the “Status” field beneath the “Quote Reference” portion now states that the quote is “Verified”. FIG. 2(d) also shows that, at any time during the quoting process, the agent can navigate to a previously saved screen from the “Go To” drop-down menu selection to modify the existing quote that is displayed by selecting from one of the links to, for example, “Underwriting Information,” “Applicant,” Coverages,” “Additional Coverages and Exclusions,” “Premises,” “Schedule,” etc.

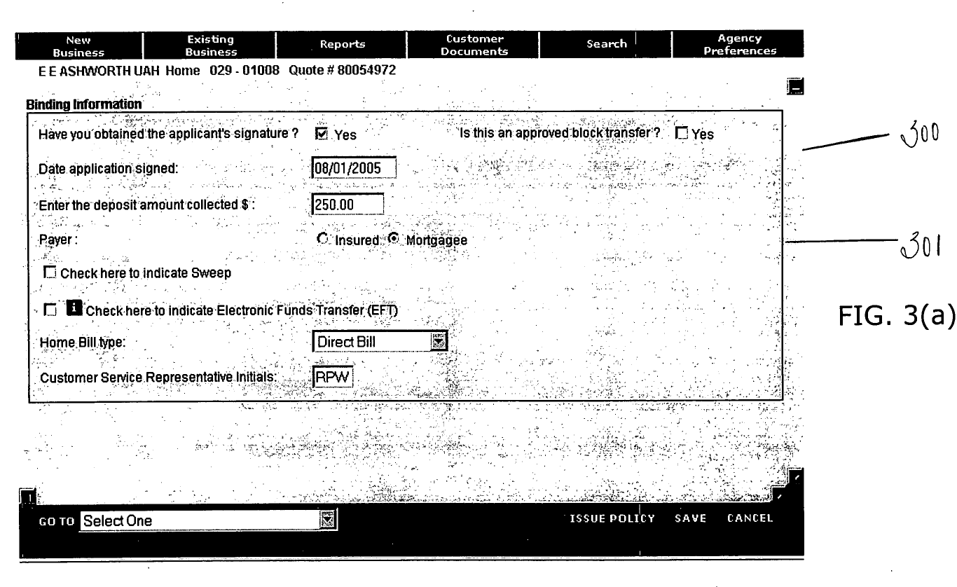

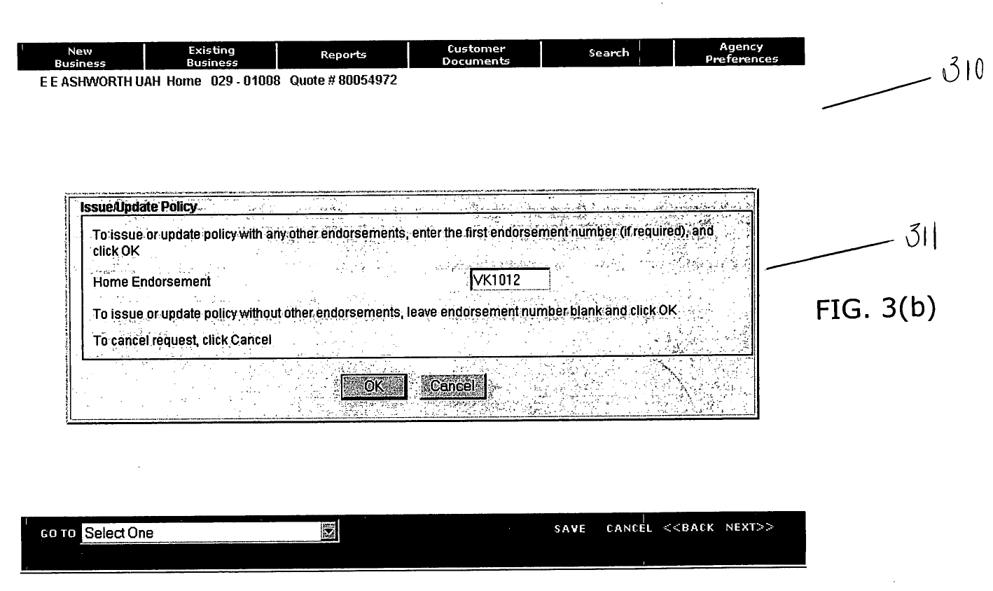

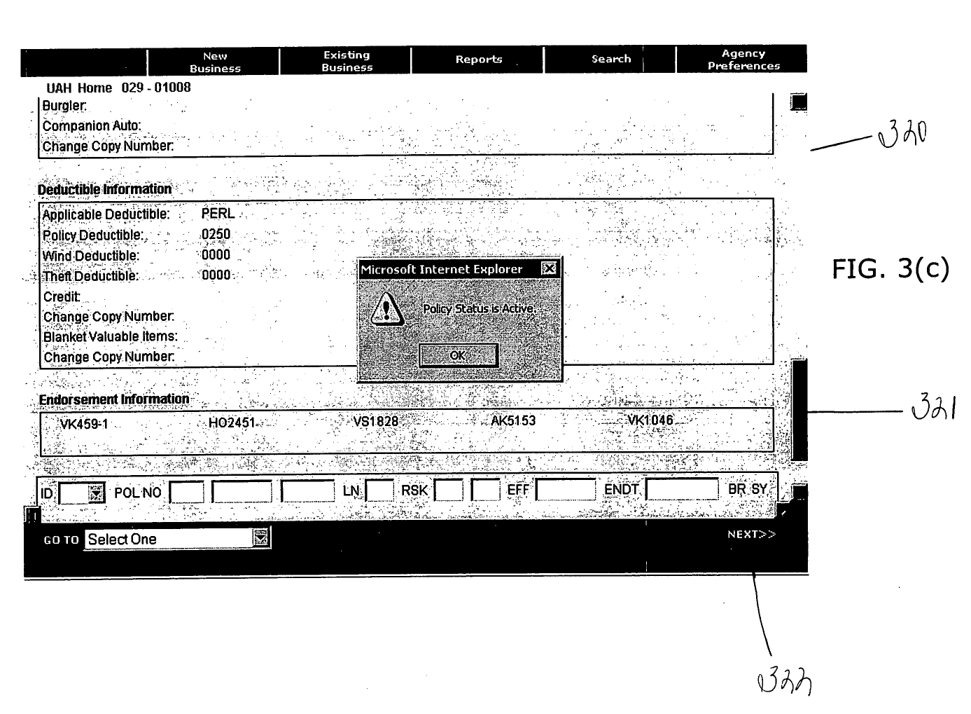

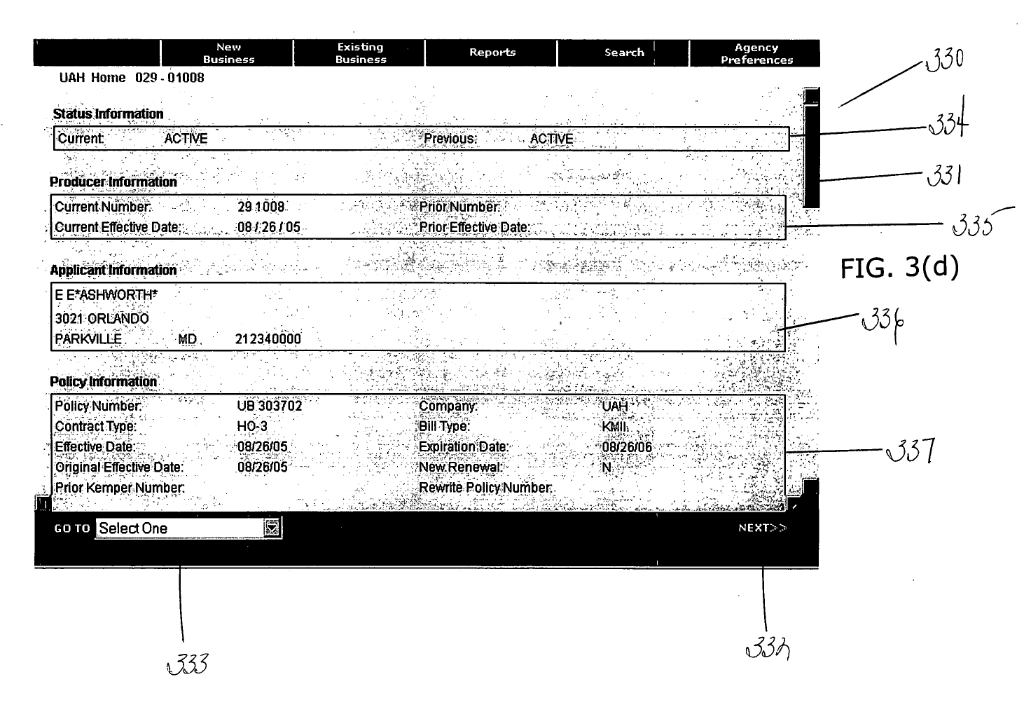

In the next phase, shown in FIGS. 3(a)-(e), the policy that is the subject of the quote is issued. The agent must “bind” the quote and confirm that a signed application will be maintained in their office. FIG. 3(a) depicts a “Bind Quote” screen 300 including a “Binding Information” portion 301. The “Binding Information” portion 301 provides a box in which the agent must check that the agent has obtained the applicant's signature on the application, as well as data input fields for the agent to enter the date on which the application was signed and a deposit amount collected. A box is also provided for the agent to indicate whether or not the application is part of an approved block transfer. The agent is also instructed to input the payor, whether the insured or the mortgagee, with further data entry boxes for entry of an affirmative mark if, for example, a third party payor is indicated or if the funds are to be transferred by an electronic funds transfer (EFT). The latter EFT box is also provided with an information tag. Additional fields are provided for entry of or selection of the home bill type and the customer service representative initials.

FIG. 3(b) presents an “Issue/Update” screen 310 comprising an “Issue/Update” portion 311 providing for additional endorsements. The agent is instructed to “issue or update the policy with any other endorsements, enter the first endorsement number (if required), and click OK”. In the data entry field “Home Endorsement,” the agent is shown to have entered “VK1012” and the agent is instructed that to “issue or update policy without other endorsements, leave endorsement number blank and click OK”. Thus, in screen 310, additional billing information is completed and another opportunity is given to add any endorsements that were not initially added to the quote.

Following submission and short processing time, a “Policy Activation Confirmation” screen 320 appears (e.g., pop-up) indicating that the policy status is now “Active,” as shown in FIG. 3(c). Navigation tools include a sliding navigation bar 321 to permit the user to move up and down through the policy information and a “Next” button 322 permits the user to move to the next data entry screen, shown in FIG. 3(d). In FIG. 3(c), the navigation bar 321 is shown to be disposed toward a bottom portion of the policy.

FIG. 3(d) provides a “Policy Risk Summary” screen 330 having a navigation bar 331, a “Next” button 332, and a “Go To” pull-down menu 333 for navigation. FIG. 3(d) also provides a “Status Information” portion 334, a “Producer Information” portion 335, an “Applicant Information” portion 336, and a “Policy Information” portion 337. It is noted that additions portions of the “Policy Risk Summary” screen 330 are not shown in FIG. 3(e).

The “Status Information” portion 334 of FIG. 3(d) merely shows that the Current and Previous Status of the policy was “Active.” From prior data entry screens, the “Producer Information” portion 335 reflects that the producer in this example was “29 1008” and the current effective date of the policy (e.g., Aug. 26, 2005) and the “Applicant Information” portion 336 contains the expected applicant information. The “Policy Information” portion 337 includes coded entries for the “Policy Number,” “Contract Type,” “Company,” and “Bill Type” with additional data fields showing the effective date and expiration date of the policy.

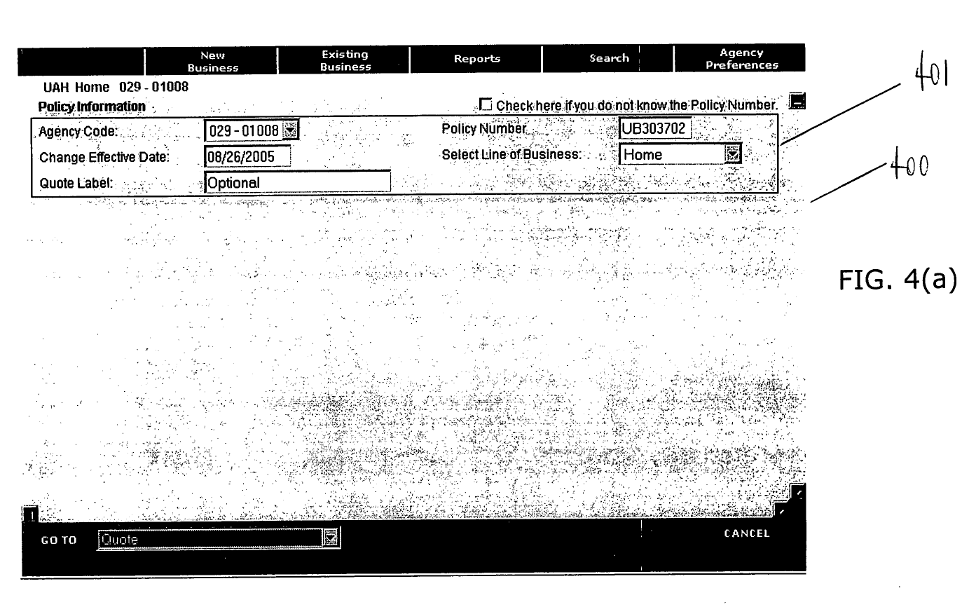

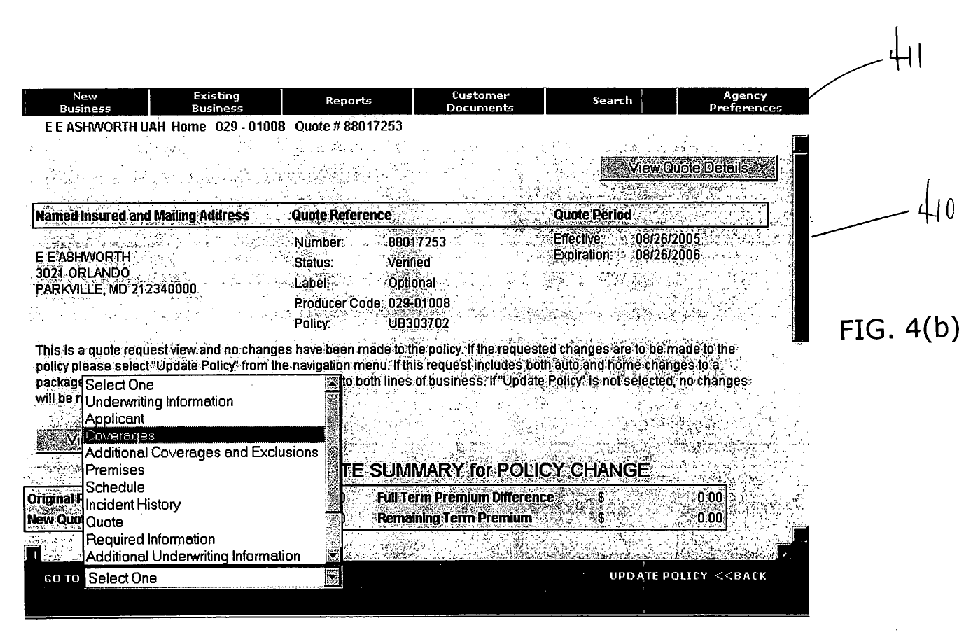

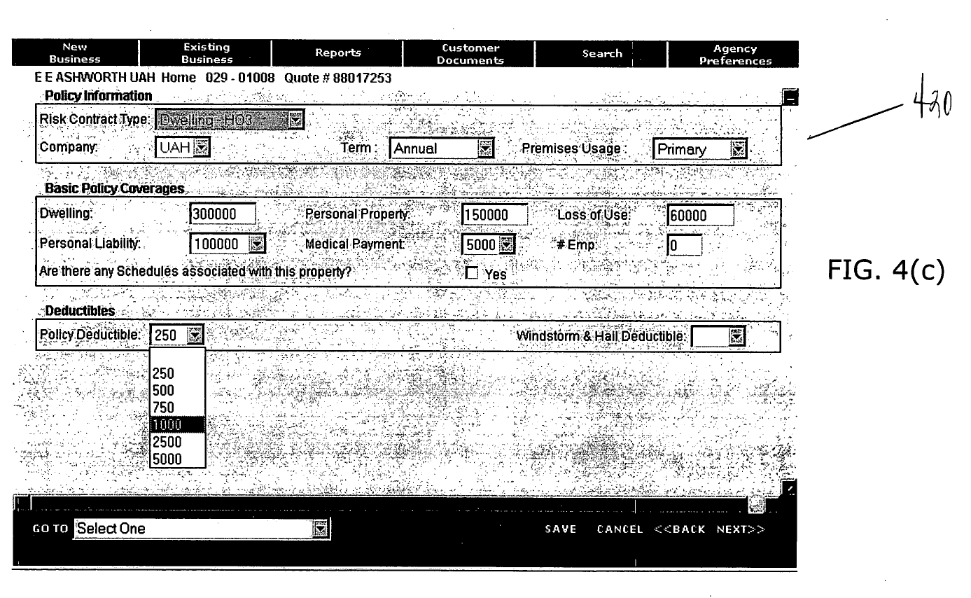

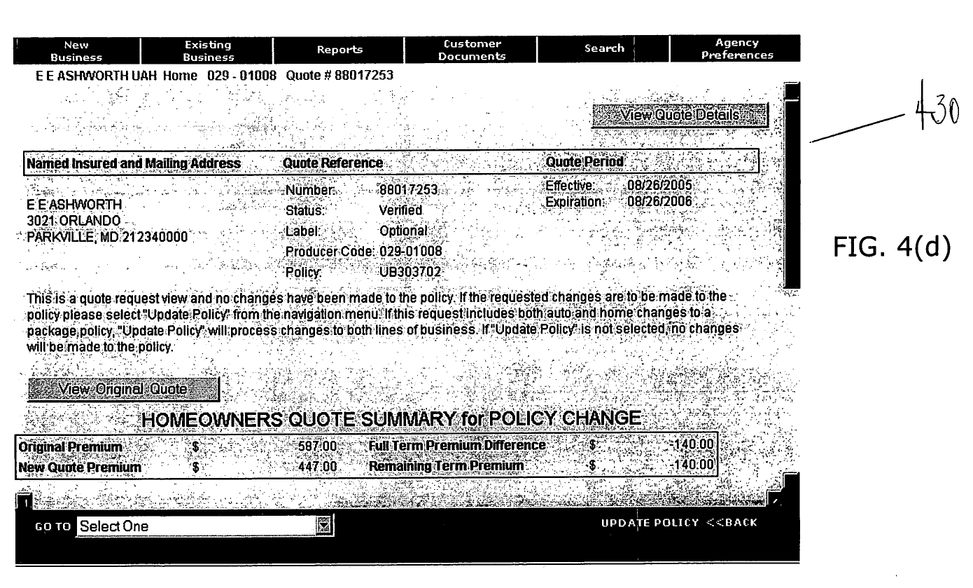

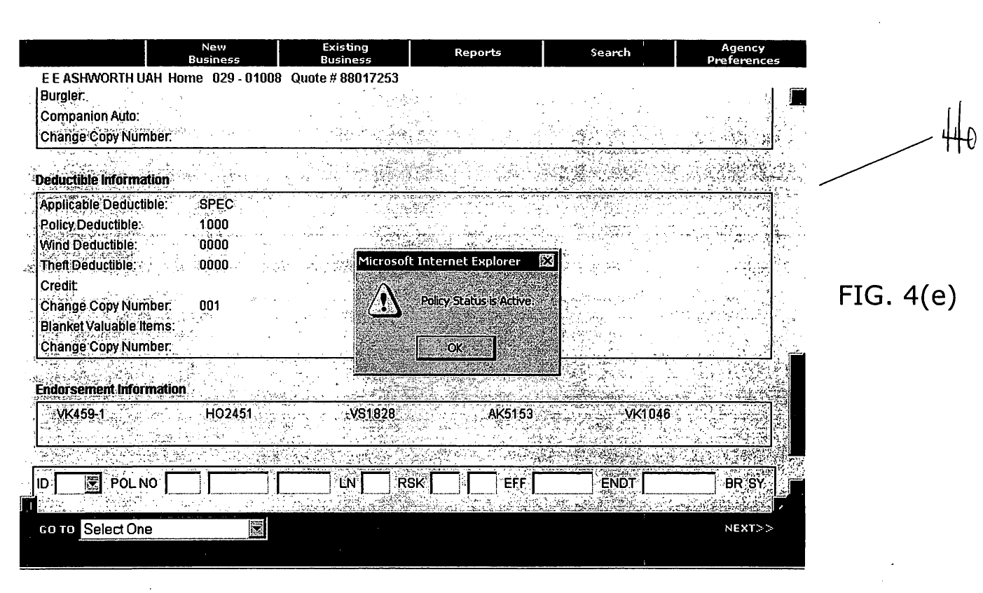

The above FIGS. 1(a)-3(d) covers new business, particularly the issuance of a quotes and the issuance of a policy in the example of home insurance. The phase depicted below covers policy changes and updates. Quotes can be created for any active policy without making a policy change update. For example, a customer might want to change the level of their deductible. FIGS. 4(a)-(e) describe such an example wherein a quote is provided to a change to a deductible and the application will update the policy with that existing quote data.

FIG. 4(a) shows a “Policy Change” screen 400 comprising a “Policy Information” portion 401 showing the “Agency Code,” “Change Effective Date,” “Policy Number,” and “Line of Business,” with an optional “Quote Label.” The “Go To” field at the bottom of the “Policy Change” screen 400 is highlighted, indicating that this screen was displayed in response to a selection of the “Quote” screen from the “Go To” pull-down menu. FIG. 4(b) shows a “Quote Summary” screen 410 which shows information relating to the insured and to the insured's policy, with messages noting that the illustrated screen is merely a quote request and that no changes have been made to the policy and noting that if the requested changes are to be made to the policy, the user must select “Update Policy” from the navigation menu following selection of the “Existing Business” link in menu-bar 411. In FIG. 4(b), the agent is shown to use the “Go To” pull-down menu to highlight and select “Coverages”.

FIG. 4(c) shows the associated “Coverages” screen 420, which is similar to that of FIG. 1(c). In FIG. 4(c), the agent is shown to have highlighted “1000” from the drop-down menu item for “Policy Deductible,” which value had previously been “250.” FIG. 4(d) then shows an “Updated Quote Summary” screen 430 showing, at the bottom, that the “Original Premium” for the deductible of $250 is $587.00, whereas the “New Quote Premium” for the deductible of $1000 would be $447.00. FIG. 4(d) also shows that the “Full Term Premium Difference” as well as the “Remaining Term Premium” would be “−$140.00.” Lastly, FIG. 4(e) shows a “Policy Change Confirmation” screen 440, wherein it is indicated that the policy status is active, confirming the change to the policy following the agent's selection of the “Update Policy” option from the navigation menu, as noted above.

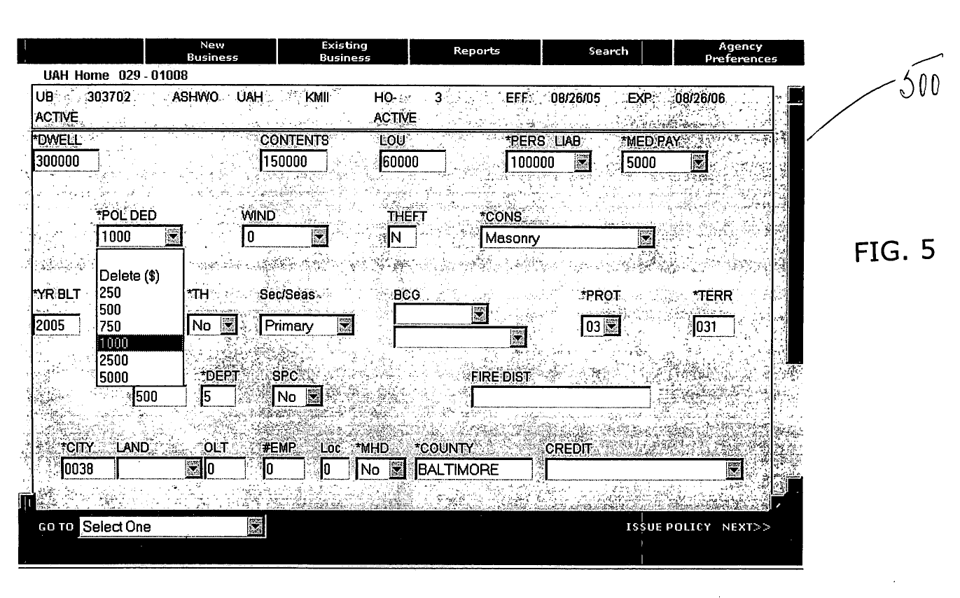

FIG. 5 shows an example of a mainframe (PLIS) screen 500. As noted above, the PLIS system is code driven and the application described by way of example in FIGS. 1(a)-5 provides an internet-based front end look to these screens, but they are still code driven. Some transactions are not supported in the application described above, but are supported in PLIS, and access to PLIS is granted to agents to complete these transactions.

However, many agents do not know the definition of these mandatory codes and experience difficulty navigating to, and within, these PLIS screens, as well as difficultly in completing these unsupported application internet-based transactions. The use of the navigation tools themselves sometimes present problems and introduce inefficiencies. For example, vertical and horizontal sliding bars are, at times, overlooked and information residing “off screen” is sometimes initially missed. The application discussed in the succeeding figures includes improves to the above application (i.e., FIGS. 1(a)-5) and, inter alia, makes all transactions available to the agents in simplified form and frees the agents from PLIS for these transactions.

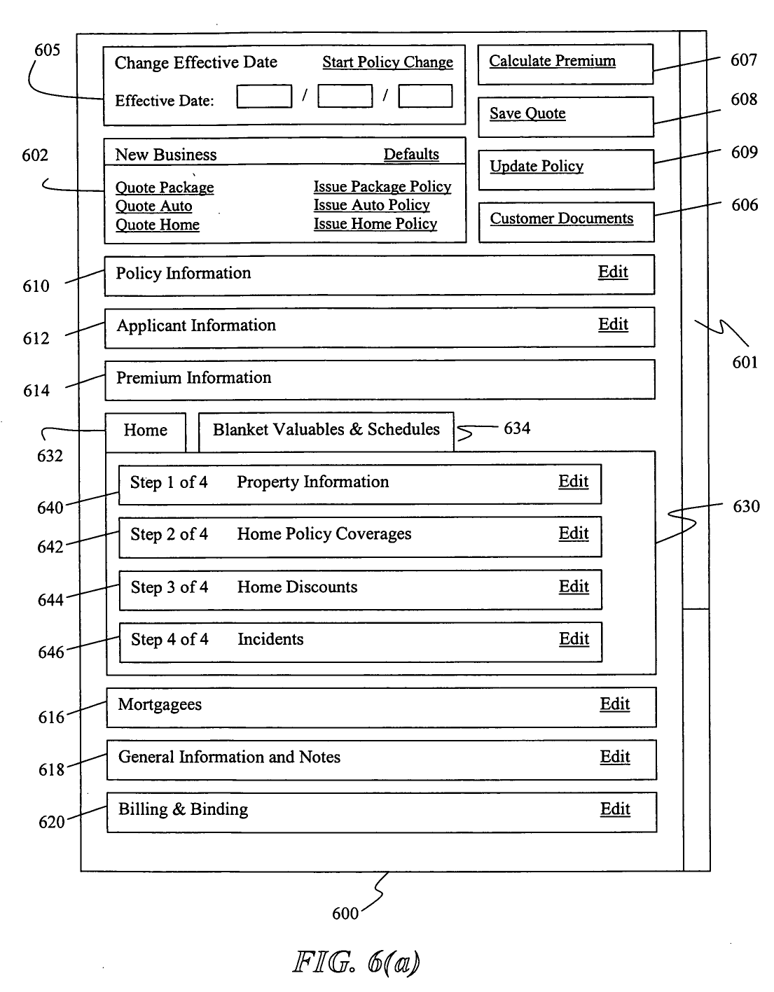

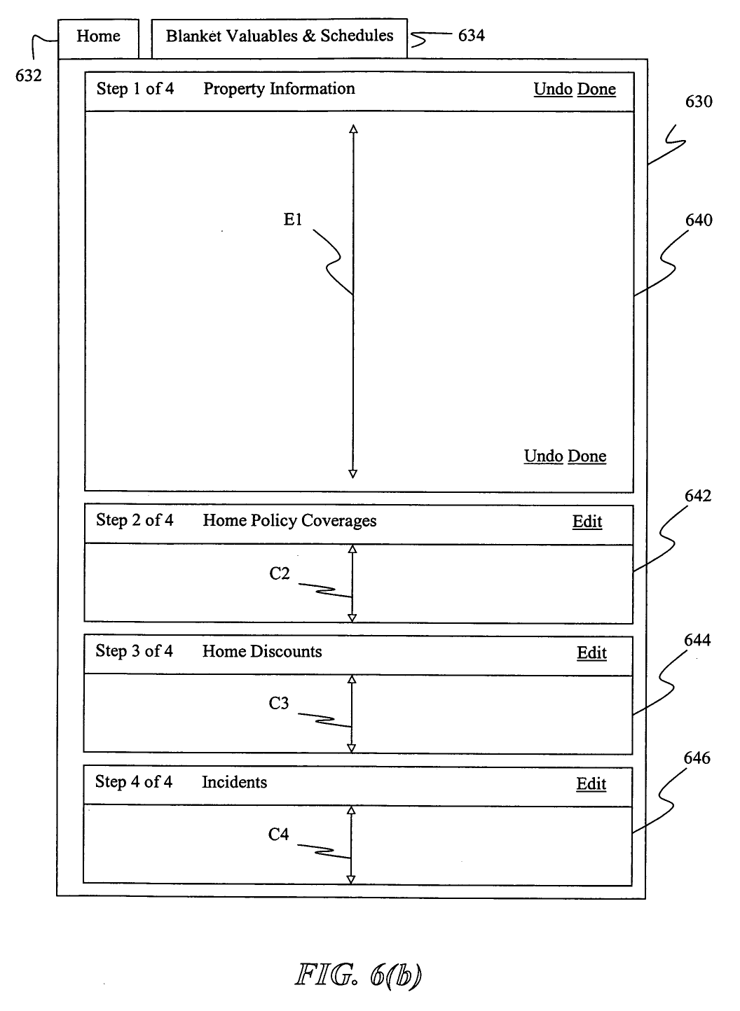

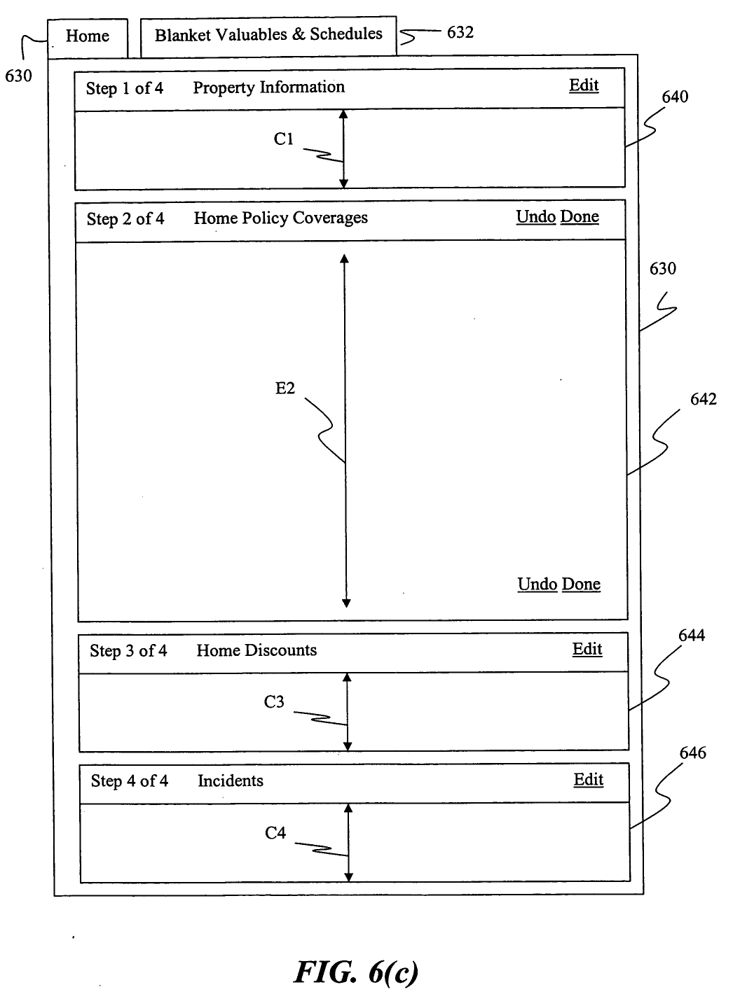

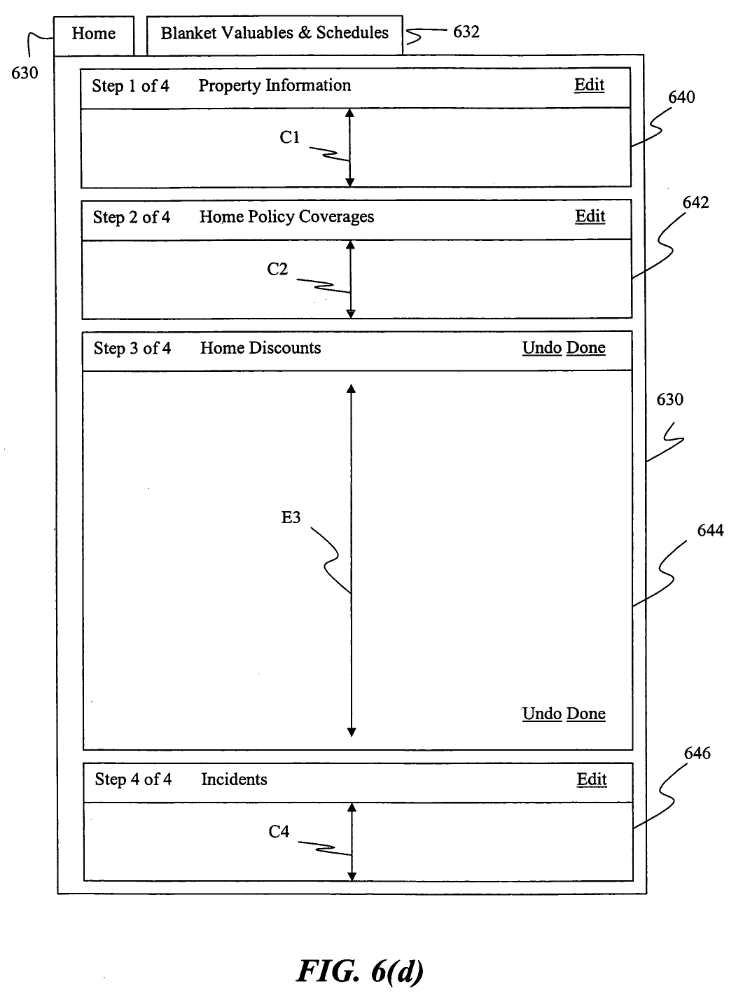

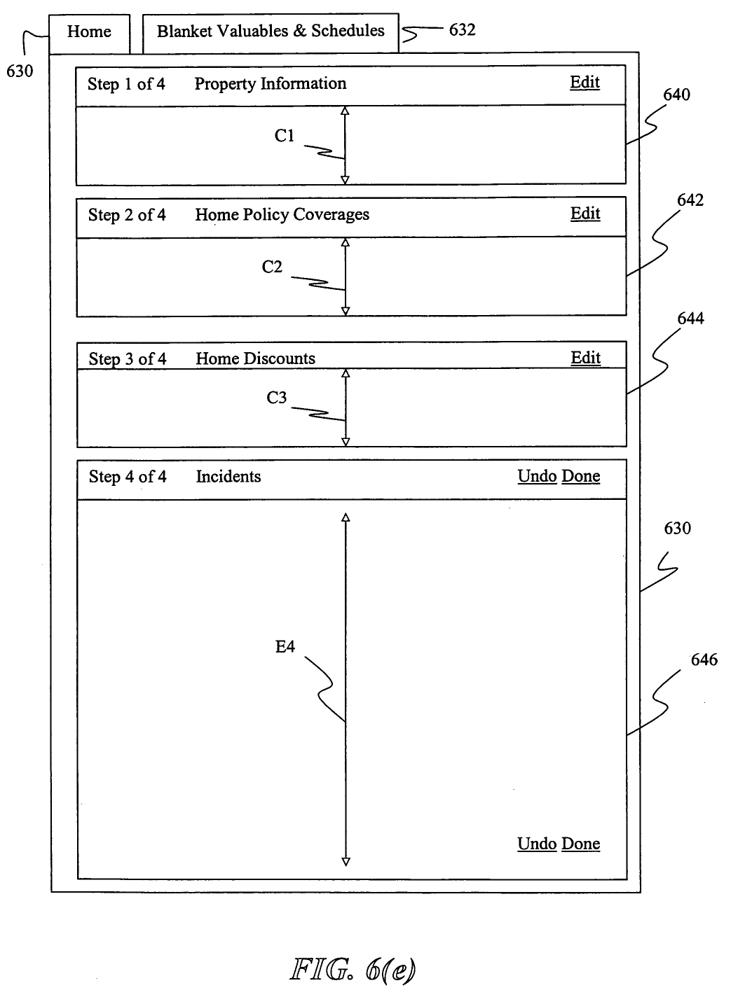

The application described by way of example in FIGS. 6(a)-8(d), denoted as RightPrice Web 6.0 herein, incorporates all existing functionality presented in FIGS. 1(a)-5. A notable difference in the RightPrice Web 6.0 lies within the design and flow of the user interface. The application covered in FIGS. 1(a)-5 navigates the user screen by screen through the use of the various “Next” and “Back” buttons. Navigation of the agent through the process of preparing a quote and then processing a policy requires up to 15 screens to be completed. As represented by way of example in FIG. 6(a), in at least some embodiments, the RightPrice Web 6.0 application uses only one main screen 600, denoted as the “Dynamic Declaration” page or the “Dynamic ‘Dec’”.

The main screen 600, such as shown in FIG. 6(a), provides a logical base from which a user may access various databases, data entry screens, and fields mainly, if not entirely, through hypertext links (e.g., the underlined text in FIG. 6(a)). The horizontal and/or the vertical sliding navigation bars may optionally be omitted. This configuration of functional links between the main screen 600 and other associated screens improves not only the presentation of data to the agent within a single screen, but improves the overall flow and continuity of transitions between the associated screens, speeding data entry and processing of quotes, applications, and edits.

Since the RightPrice Web 6.0 application, such as is shown in FIGS. 6(a)-8(d) herein by way of example, incorporates the functionality of the application described above in FIGS. 1(a)-5, the following discussion does not reiterate such functionality for brevity. Instead, the discussion below emphasizes at least some of the features the RightPrice Web 6.0 application in relation to FIGS. 6(a)-8(d).

As discussed above with respect to FIGS. 1(a) and 5, the mainframe (PLIS) is code-driven and requires agents to access the coded screens to obtain support for certain transactions. Other PLIS transactions are not available for agents to perform (i.e., PLIS unsupported transactions). Access to these PLIS unsupported transactions is limited to internal underwriting processing department employees so that control may be maintained over what is written and what is modified. PLIS unsupported transactions include, but are not limited to (1) package cancellation, (2) modification or removal of a loss or conviction, (3) overriding of a tier, (4) removal of a previously processed policy change, (5) reinstatement of a policy, and (6) non-renewal of a policy. Other PLIS unsupported transactions having limited or restricted access to both agents and internal underwriting processing department employees might arise from functional restrictions, such as a locked database or an open database currently in use by another user.

In at least some embodiments of the present concepts, agents requesting a change that is not supported by the RightPrice Web 6.0 application will automatically route the agent (i.e., any user) to a data entry field, tile, window, or screen enabling the agent to request the underwriting processing department employees to perform the change. Some changes can be performed in PLIS but not in the RightPrice Web 6.0 application. These include, for example, (1) a policy change is needed prior to the effective date of a current policy change on the policy, (2) a policy change is needed on a renewal policy that has yet to be renewed [future term], or (3) a policy has unrecognized data that is expired for new business in the RightPrice Web 6.0 application but grandfathered on a current policy in PLIS. Unrecognized data can be, for example, a coverage no longer offered for new business, a deductible, a territory code or an endorsement. In these examples, the agent is routed to a data entry field, tile, window, or screen enabling the agent to request the underwriting processing department employees to perform the change for them in PLIS.

In accord with at least some aspects of the RightPrice Web 6.0 application, illustrative examples of which are depicted in FIGS. 6(a)-8(d), a “Facade” feature may be optionally provided. The Facade feature provides the agent with determinative responses to unsupported transactions, some of which are noted above. For example, if the user attempts to cancel a policy, the cancellation of a policy being an unsupported transaction, the Facade feature will make it appear to the agent that the transaction has been received and processed and will output to the agent a “transaction complete” message even though the transaction may not yet be complete. Contemporaneously with the message of “transaction complete” to the agent in the above example, the Facade feature sends an email or uses another communication pathway to inform the underwriter processing center of the request (e.g., the attempted cancellation). The underwriter processing center will then complete the transaction, on behalf of the agent, within the company mainframe computer (e.g., PLIS). In at least some other aspects, the communication by the Facade feature to underwriting processing need not be contemporaneous with the message to the agent and may occur at a later time (e.g., on a schedule, at the end of a session, etc.).

Thus, in accord with the Facade feature, agents no longer will have to remember which codes are needed for unsupported transactions and the processing of quotes and amendments and the processing of policies is improved. The Facade feature can also be used for company conversions, back-dated transactions, or even a future requests to a policy that has yet to be renewed. Additionally, the severing of the remote link to the mainframe by the Facade feature provides an additional level of data security and control of the database by the underwriter processing center.

The Facade feature noted above is one of a number of “user-centric” features incorporated into RightPrice Web 6.0 which, for example, liberate the agent or user from tasks that may be more efficiently performed by the underwriter's central processing department, empower the agent to independently perform tasks that had previously required the input of the underwriter's central processing department, and/or facilitate data entry. Another feature integrated within the RightPrice Web 6.0 application, shown in FIGS. 6(a)-8(d) and successive figures, is a “quote copy function.” In accord with this feature, the data associated with data fields in an existing policy (e.g., a home policy) may be copied, wholesale, and imported into corresponding data fields in a policy quote for another type of policy (e.g., an auto policy). Thus, if an agent wants to up-sell a policy, the agent can simply click on a link (e.g., from the “Quote Auto” link in the “New Business” tile 602 of FIG. 6(a)) from within a policy holder's main screen 600 and create a largely filled-in quote template from the existing data without duplicate entry of the policy-holder's data. This “quote copy function” thus provides for the rapid and efficient creation of quotes for additional policies for existing policy holders.

Another feature provided within the RightPrice Web 6.0 application to assist the agents is the addition of a brochure mailing function as a part of the overall “Customer Documents” tab or button 606, such as is shown in FIG. 6(a). In other words, whereas the “Customer Documents” feature previously concerned the generation of quote and policy related documentation, the “Customer Documents” feature may not be used by the agent to email to the customer information on any particular product directly from the application. These brochures may be stored in a non-alterable format (e.g., PDF) within a general “Customer Documents” database so that agents can easily save and email these documents to their customers.

Another feature included within the RightPrice Web 6.0 application is a “Tabs” feature. In at least some aspects, tabs (e.g., 630, 632 in FIGS. 6(a)-(e)) are reserved for a line of business that is being offered. By way of example, FIGS. 6(a)-(e) show a “Home” tab 630 and a “Blanket Valuables & Schedules” tab 632 associated with. If the example of FIGS. 6(a)-(e) was for a package quote, a tab (not shown) for “Auto” would also be provided because “Auto” is another line of business offered in a package policy. In at least some other aspects, all lines of business may be incorporated into such tabs including, but not limited to, “Boat Owners” and “Umbrella” coverages. In the “Blanket Valuables & Schedules” tab 632, the schedule personal property may be itemized, such as entry of the item information into a plurality of data fields or by selection of boxes adjacent items corresponding to the personal property for which coverage is desired. It at least some embodiments of the RightPrice Web 6.0 application, an agent is permitted to quote, itemize, remove, and update specific detailed items or even delete a class of items (e.g., jewelry, computers, etc.) or the entire schedule. The “Blanket Valuables & Schedules” tab 632 may thus permit entry of the schedule personal property information by the agent, rather than requiring entry of the schedule personal property information by the underwriting processing center, as required in the example of FIGS. 1(a)-5.

Further, of the various data fields and text presented to guide the agent's input of data pertinent to a desired transaction, the application may advantageously highlight those fields that are required for a quick quote using an asterisk (e.g., *). Fields that are not required for a quote or for policy issuance may be italicized. Additionally, the text required for policy issuance would include not only the text identified by an asterisk, but would also include those fields that are provided in a normal font. These conventions may optionally be changed, in accord with aspects of the present concepts, to utilize other manners of visually distinguishing the quote, policy issuance, and optional fields from one another including, but not limited to, changing aspects of the font, color, appearance, shape, background, persistence, and/or borders.

In at least some embodiments of the RightPrice Web 6.0 application, aspects of which are depicted in FIGS. 6(a)-8(d), a plurality of data fields are displayed on, or linked directly to, the main screen 600. In the example of FIGS. 6(a)-8(d), related data fields are grouped together in “tiles,” such as the “Policy Information” tile 610, the “Applicant Information” tile 612, the “Premium Information” tile 614, the “Mortgages” tile 616, the “General Information and Notes” tile 618, and the “Billing & Binding” tile 620. Other tiles in FIG. 6(a) are shown to be grouped together in a tile 630 including a separate “Property Information” tile 640, “Home Policy Coverages” tile 642, “Home Discounts” tile 644, and “Incidents” tile 646.

Similar to the example of FIGS. 1(a)-5, the example of FIGS. 6(a)-8(d) provides a sequence of data entry or required workflow in which the user is guided to complete certain fields before proceeding to complete other fields. However, in the example of FIGS. 6(a)-8(d), each step is completed when the user fills in the required data on the tile associated with that step and, once a tile is completed, the user is then guided to the next step by the “collapse” of the completed tile and the “expansion” of a new tile (i.e., the next tile in the sequence).

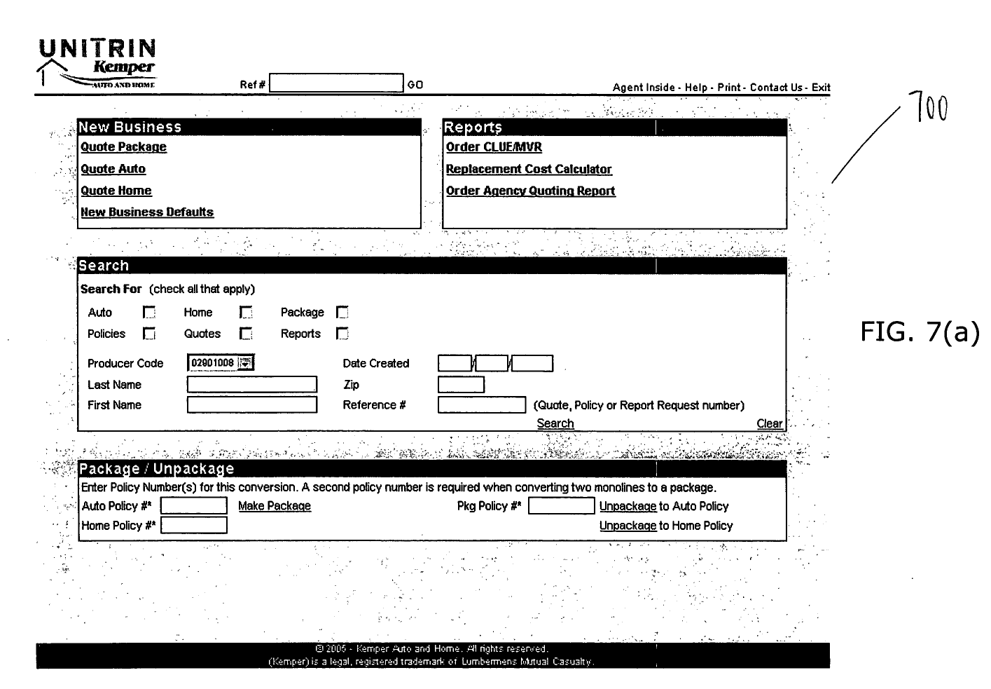

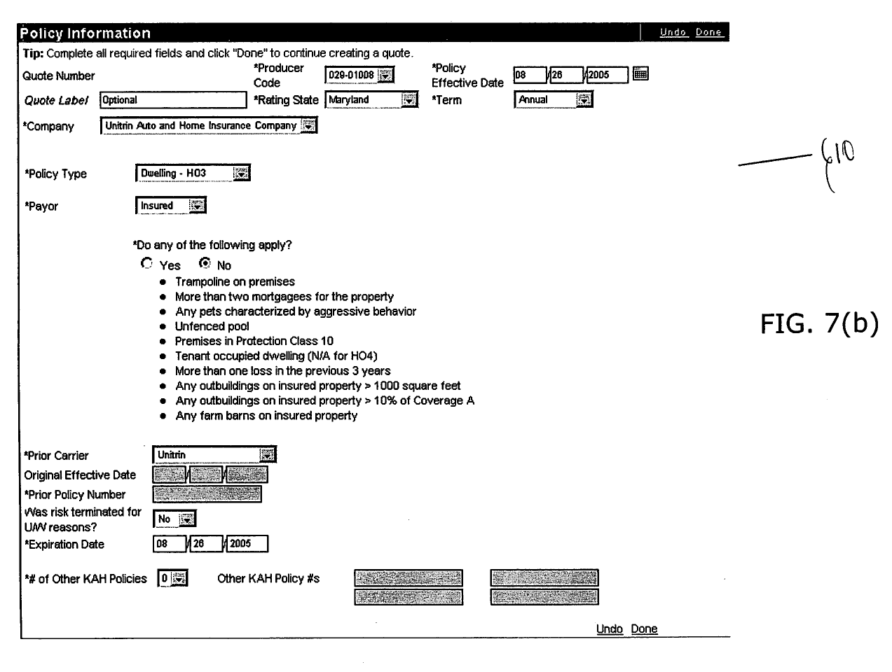

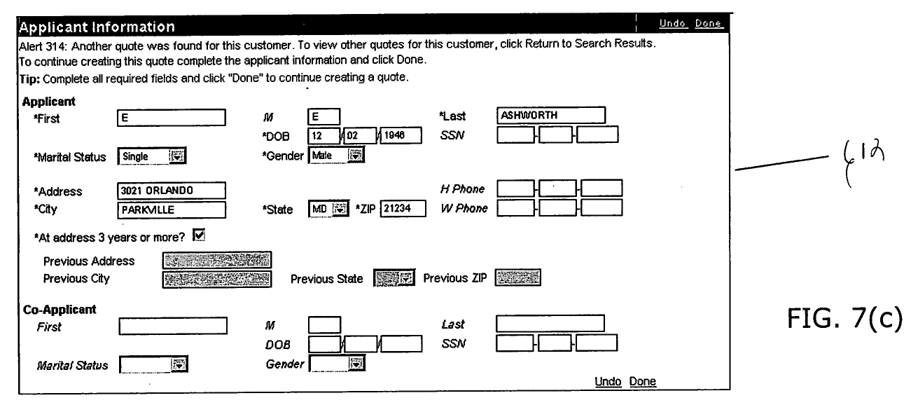

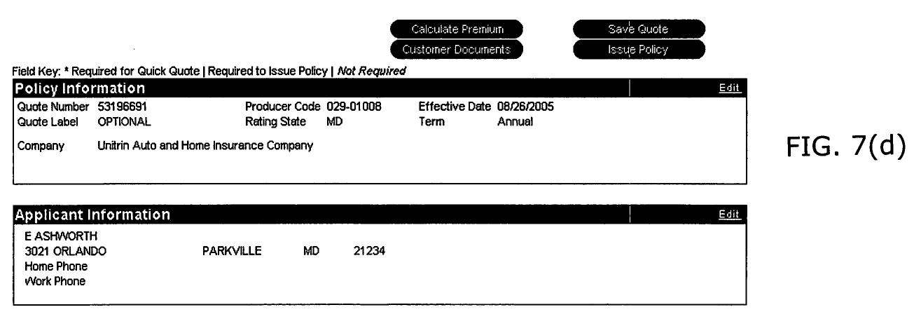

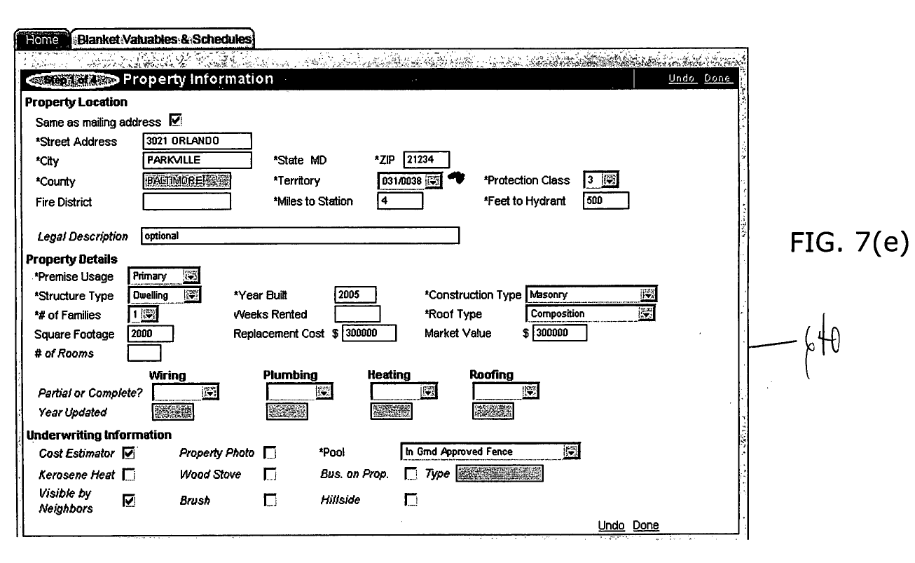

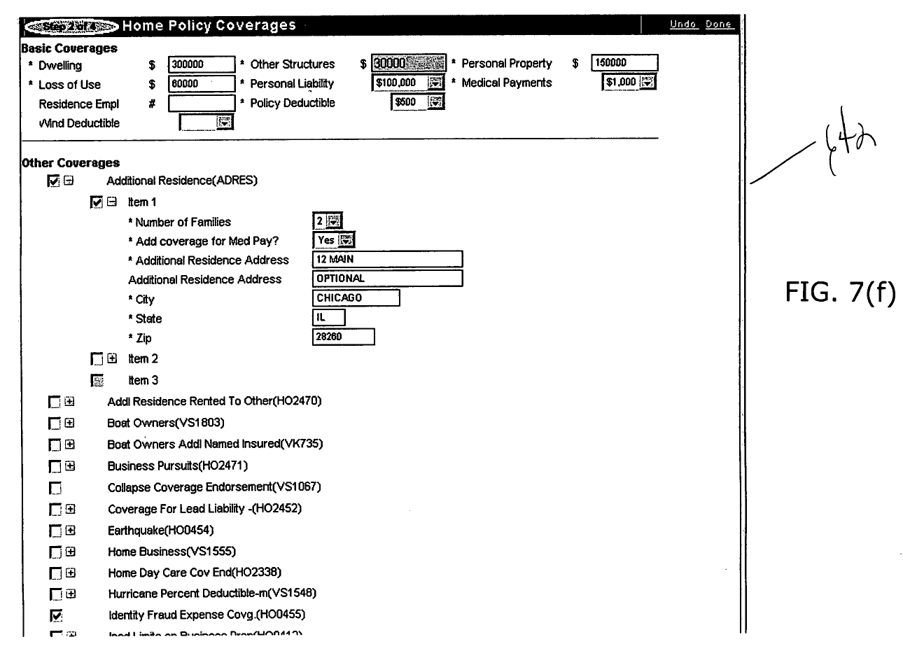

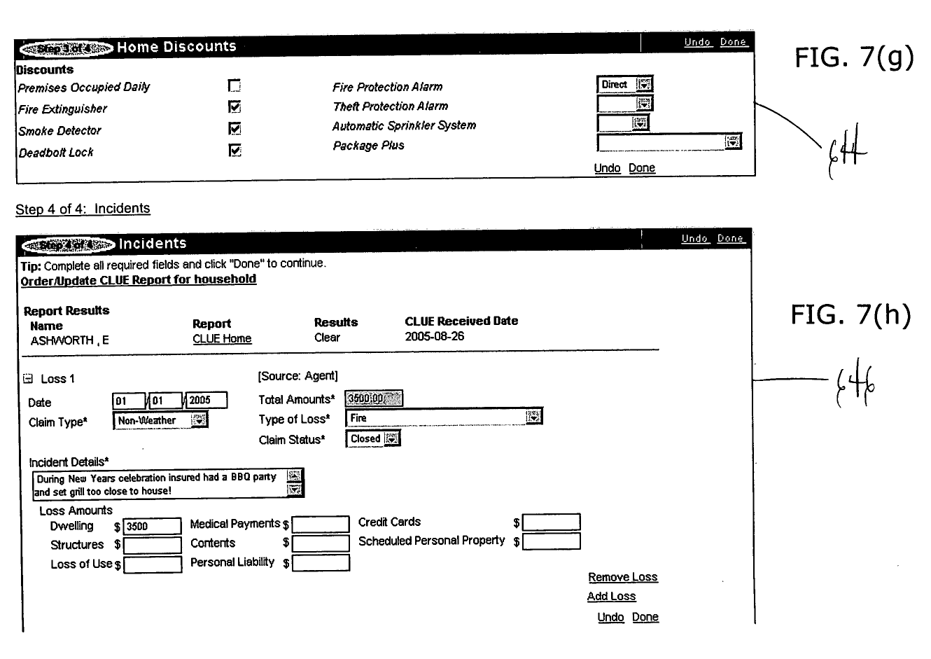

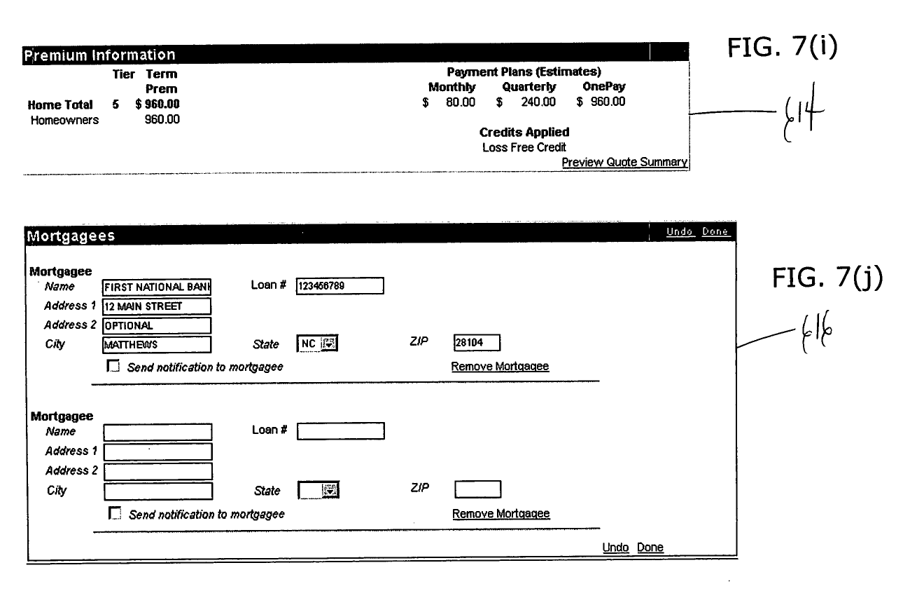

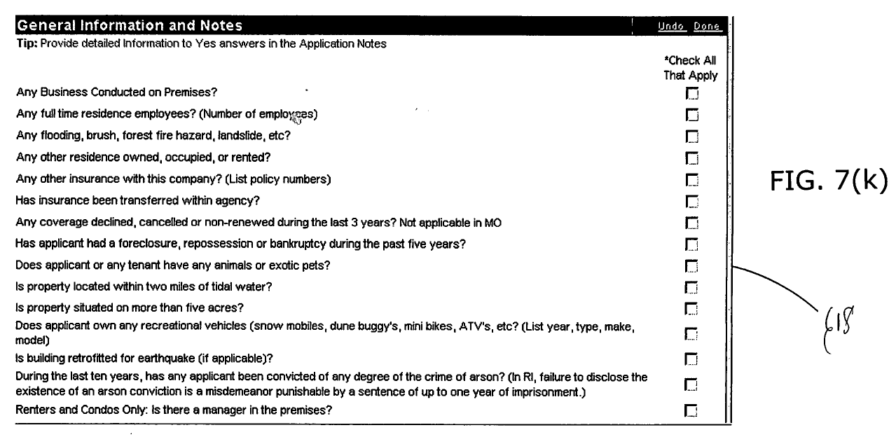

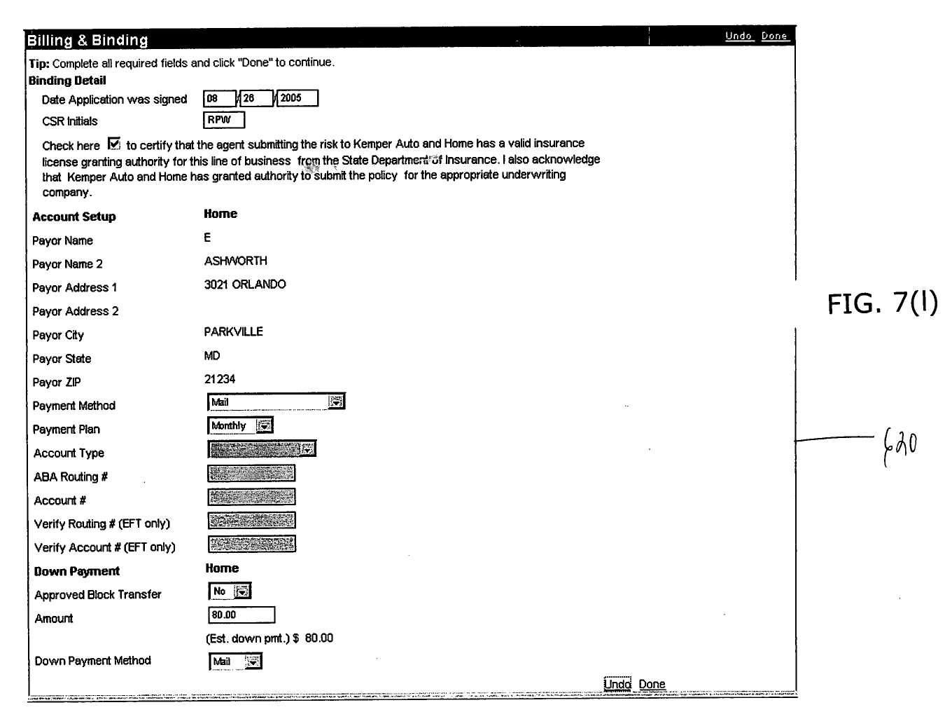

As shown more clearly in FIGS. 6(b)-6(e), one sequence of expansion and contractions is used to illustrate an example of navigation using the main screen 600 or “Dynamic ‘Dec’”. FIG. 7(a) shows a screen-shot of an example of a main screen 700 or “Dynamic ‘Dec’”.

To illustrate one example of operation, an agent may initiate a new business quote for a home policy by clicking on the “Quote Home” link (e.g., hypertext) in the “New Business” tile 602. For convenience, the “New Business” tile 602 is illustrated as being on main screen 600. Alternatively, the “New Business” tile 602 may be disposed on another entry screen, which leads to the main screen 600. Upon activating a link associated with the “New Business” tile 602, the “Policy Information” tile 610, or other tile associated with the required transaction, expands from a collapsed state, shown by way of example in the “Summary Screen” of FIG. 7(d), to the expanded state, shown by way of example in FIG. 7(b). Following data entry, the “Policy Information” tile 610 collapses to be replaced by an “Applicant Information” tile 612, which expands from the collapsed state shown in the “Summary Screen” of FIG. 7(d), to the expanded state shown by way of example in FIG. 7(c).

Following entry of the pertinent data in the “Policy Information” and “Applicant Information” tiles 610, 612, the agent is directed to the tile 630 and, more particularly, to an expanded view of the “Property Information” tile 640, as indicated by the arrow E1 shown in FIG. 6(b). In FIG. 6(b), the remaining tiles 642, 644, and 646 within tile 630 remain in a collapsed state (i.e., C2, C3, C4, respectively). The representation of FIG. 6(b) is illustrated in more detail in the exemplary screen-shot of FIG. 7(e), which comprises data fields found collectively in FIGS. 1(f) and 2(a). When the agent completes the data entry in the “Property Information” tile 640, the agent may be automatically directed to the “Home Policy Coverages” tile 650 or the agent may enable the navigation change by clicking on the “Done” hypertext within tile 640. In the screen-shot of FIG. 7(e), many of the boxes disposed adjacent the individual “Other Coverages” and configured to receive a check mark or other affirmative indication of selection are have disposed adjacent thereto a “[+]” or “[−]” icon. These icons permit an agent to expand or contract, respectively, the information associated with such individual coverages. FIG. 7(e) particularly shows an example wherein the “Additional Residence” coverage has been expanded to reveal an expanded “Item 1” and a contracted “Item 2.”

As represented in FIG. 6(c), when the tile 640 is closed, it collapses to a smaller size, as represented by the arrow C1. Likewise, the collapsed tile 642, indicated by arrow C1 in FIG. 6(b), expands into the expanded view of tile 642, as indicated by the arrow E2 shown in FIG. 6(c). Similarly, navigation through successive tiles 644, 646, such as represented by FIGS. 6(d)-(e), involves the collapsing (e.g., C3, C4) and expanding (e.g., E3, E4) of tiles to present a sufficient view of the data fields requiring entry while maintaining an overall continuity or commonality between the tiles.

By way of example, the data fields presented in the expanded view of the “Property Information” tile 640 may be seen in the example screen-shot of FIG. 7(e). Similarly, examples of screen-shots representative of data fields which may be found in the “Home Policy Coverages” tile 642 may be found in FIG. 7(f). FIG. 7(f) comprises fields which are shown in FIGS. 1(c), 1(d), and 1(e). An example of a screen-shot representative of the data fields which may be found in the “Home Discounts” tile 644 may be found in FIG. 7(g). An example of a screen-shot representative of the data fields which may be found in the “Incidents” tile 646 is shown in FIG. 7(h).

Following the input of the pertinent information in each of the above-noted tiles 610, 612, 640, 642, 644, and 646, the “Premium Information” tile 614 is expanded minimally to show the calculated premium, such as shown in the exemplary screen-shot of FIG. 7(i). As shown in FIG. 7(i), a hypertext link “Preview Quote Summary” is provided to permit the agent to preview specific details underlying the premium.

The term collapse, as used herein, includes, but is not limited to, an actual disappearance of the tile, a minimization of the tile (i.e., reduction of the tile to an icon), a reduction in size of the tile (i.e., the tile visual presentation remains the same, but its size is diminished), a reduction in the window size surrounding the data fields (i.e., the data fields remain static, but the window size within which the data is viewed is collapsed so that the persistent state data fields are not viewable) and/or a rearrangement of the data fields to omit non-essential or non-desired data (i.e., reducing the data to a summary form which automatically reduces the size of the tile). The collapse of the completed tile may be automatic, or may be performed in response to an input command from the agent, such as by clicking a cursor over one of the link labeled “Done” in FIGS. 6(b)-(e).

In one presently preferred aspect, the completed tiles collapse to occupy a predetermined portion of the display, while the next tile is automatically expanded to fill a predetermined portion of the display. In one aspect, every completed tile may display a mere title bar and an associated link (e.g., hypertext link) to a relevant database(s). In at least one preferred embodiment, the collapsed tiles may display some summary view of selected data fields. In accord with at least some embodiments of the present concepts, the agent or user desiring to update data in a specific tile may simply click the “Edit” link (e.g., hypertext) and proceed directly to enter data within the expanded tile. As used herein the term link refers generally to any instruction or instruction set accessible to a user to cause a change in state of the tile from a first state (e.g., collapsed) to at least a second state (e.g., expanded). This instruction or these instructions may, or may not, necessitate the accessing of a database (e.g., the instruction may merely alter a display of already displayed, but obscured data). In accord with the present concepts, a tile may have a plurality of accessible states including states other than expanded or contracted. Additionally, the link need not be a conventional point and click interface and may, for example, include other user interfaces including, but not limited to voice activated links.

When the agent or user is finished editing the data fields in the tile, they simply click the “Done” link (e.g., hypertext) and the tile collapses into a summary view, which may optionally be selected from one of a plurality of different summary views, each of which may substantively and/or stylistically differ. In various aspects, the completed tile may not only shrink to a collapsed state to occupy a predetermined portion of the display, but may also be configured to omit selected fields so as to facilitate ready comprehension of the data contained therein while the tile is in a collapsed state. For example, italicized or non-essential data may be omitted from the tile displayed in a reduced state. Further, the agent may be permitted to alter the displayed data fields in the main screen or in other screens, within set parameters, through the RightPrice Web 6.0 application equivalent of “Agency Preferences” option (e.g., the “Agent Inside” link at the top of main screen 600). This enables agents latitude to tailor the displayed output to suit individual preferences.

As noted above, if the agent wants to update data in a specific tile, they may simply click the “Edit” link (e.g., hypertext) and proceed directly to enter data within the expanded tile and click the “Done” link to exit the tile. In at least some embodiments, a policy change or update may be initiated by providing the effective date of that change in the “Change Effective Date” tile 605 and clicking the “Start Policy Change” hypertext therein. The agent then has the option to edit any tile, make appropriate changes, and update the policy by clicking on the “Update Policy” hypertext 609. In response to an “Update Policy” request, the agent will receive a “transaction complete” message, as noted above with respect to the Facade feature.

If the agent is instructed to proceed with a policy issuance, such as by clicking on an “Issue Home Policy” hypertext link in the “New Business” tile 602 or by any other available mechanism, the agent may then proceed to enter data in the “Mortgages” tile 616 (see, e.g., FIG. 7(l)), the “General Information and Notes” tile 618 (see, e.g., FIG. 7(k)), and the “Billing & Binding” tile 620 (see, e.g., FIG. 7(l)). In accord with at least some aspects of the present concepts, the RightPrice Web 6.0 application automatically orders a CLUE home report through an appropriate source (e.g., ChoicePoint) and such report must be obtained before a policy may be issued.

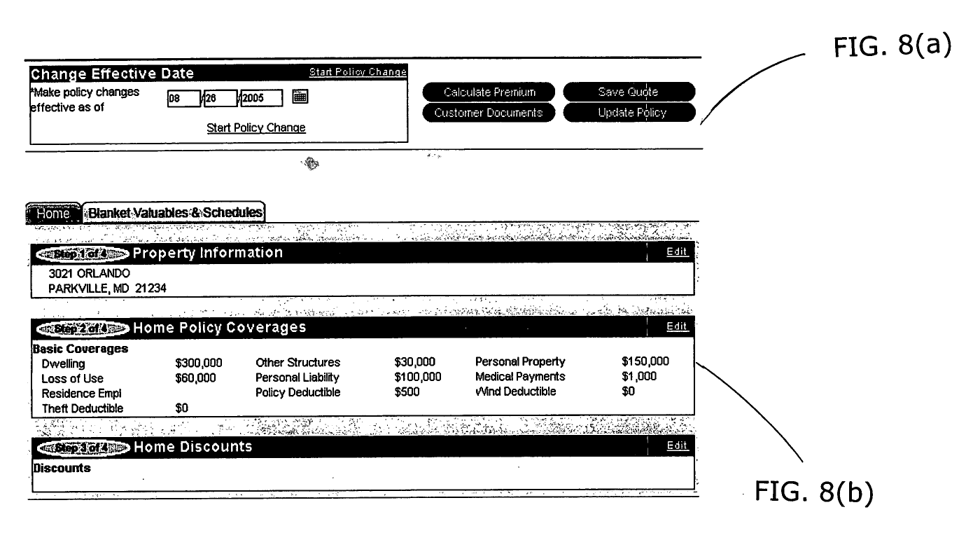

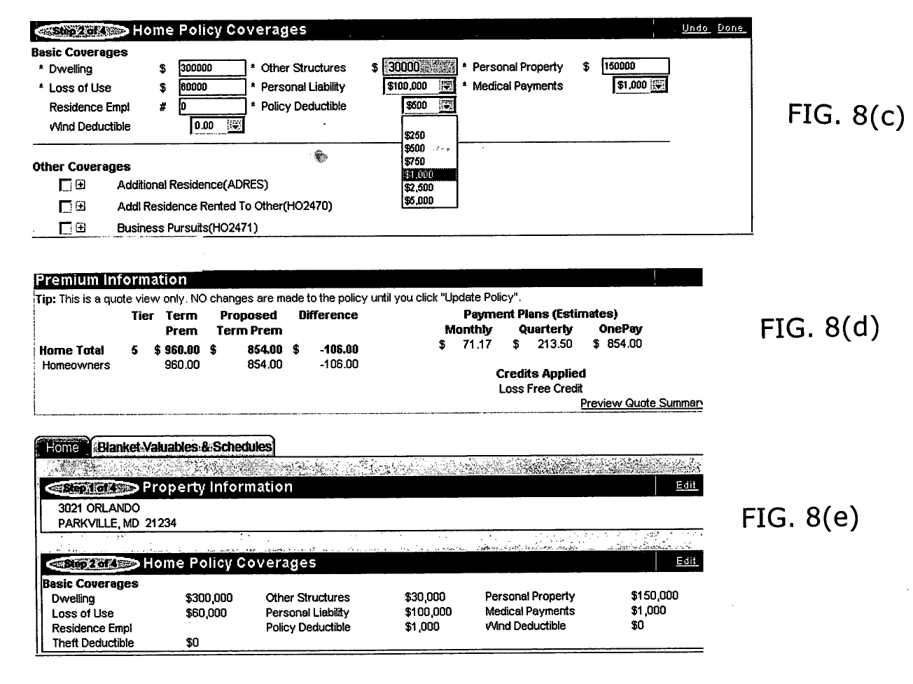

FIGS. 8(a)-(d) show examples of screen-shots illustrating a change to a policy in accord with at least some aspects of the present concepts. In this example, the agent wishes to provide a quote for a change to a coverages deductible, similar to that of the example of FIGS. 4(a)-(d). In this example, however, the agent accesses the “Change Effective Date” tile 605 in FIG. 8(a) and enters an effective date for the change (e.g., “Aug. 26, 2005”), followed by clicking on the “Start Policy Change” hypertext within tile 605. This action, for example, contracts tile 605 and expands tile 630 to highlight tiles 640, 642, 644, and 646, shown in FIG. 8(b). In this case, the agent selects the “Home Policy Coverages” tile 642 by clicking on the “Edit” hypertext. Upon this action, the remaining tiles (e.g., 640, 644, 646) collapse and the “Home Policy Coverages” tile 642 expands, as shown in FIG. 8(c). Also shown in FIG. 8(c), the agent is selecting the “Policy Deductible” data field for viewing and/or modification, as is evident from the pull-down bar displaying a plurality of conventional deductible amounts, of which the “$1000” value is highlighted. After this value is selected and displayed in the “Policy Deductible” data field, the agent may then click the “Done” hypertext to complete the change. The “Premium Information” tile 614 is then expanded contemporaneously with a collapse of the “Home Policy Coverages” tile 642 to show a difference (e.g., −$106.00) between the quoted premium to that of the original policy.

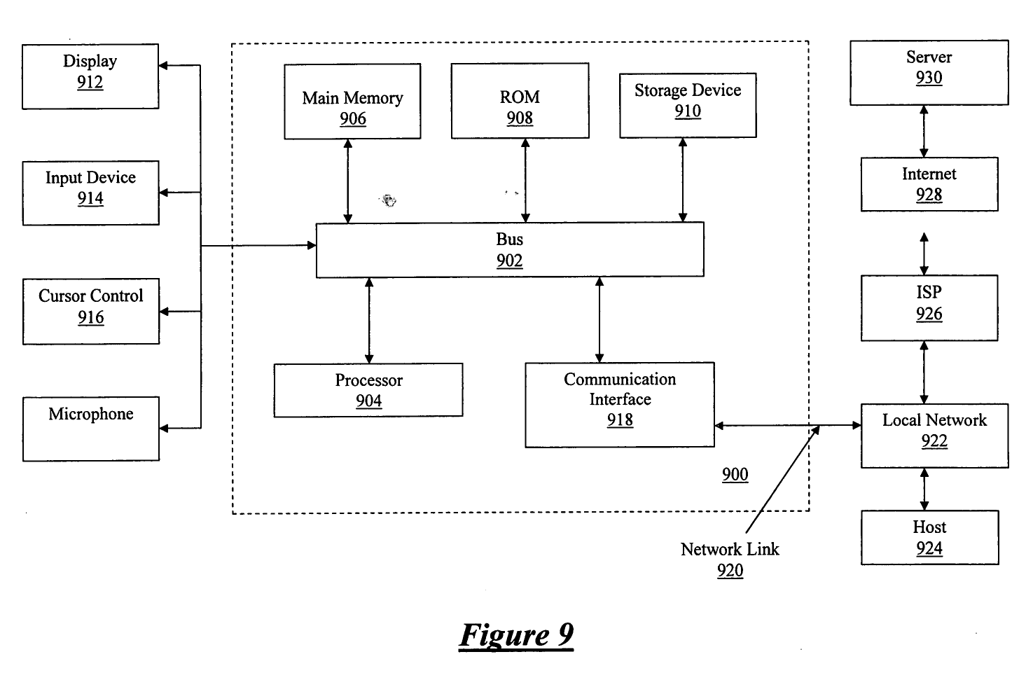

FIG. 9 is a block diagram that illustrates a computer system 900 upon which an embodiment of the invention may be implemented. Computer system 900 includes a bus 902 or other communication mechanism for communicating information, and a processor 904 coupled with bus 902 for processing information. Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

In at least some aspects, the invention is related to a graphical user interface for a computer system 900 and/or computer-software package, as described by way of example above. According to one embodiment of the invention, a graphical user interface in accord with the concepts disclosed herein may be provided by computer system 900 in response to processor 904 executing one or more sequences of one or more instructions contained in a main memory 906. Such instructions may be read into main memory 906 from another computer-readable medium, such as storage device 910. Execution of the sequences of instructions contained in main memory 906 causes processor 904 to perform the process steps described herein. One or more processors in a multi-processing arrangement may also be employed to execute the sequences of instructions contained in main memory 906. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 904 for execution. Such a medium may take many forms, including but not limited to, non-volatile media, volatile media, and transmission media. Non-volatile media include, for example, optical or magnetic disks, such as storage device 910. Volatile media include dynamic memory, such as main memory 906. Transmission media include coaxial cables, copper wire and fiber optics, including the wires that comprise bus 902. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 904 for execution. For example, the instructions may initially be borne on a magnetic disk of a remote computer. The remote computer can load the instructions into its dynamic memory and send the instructions over a telephone line using a modem. A modem local to computer system 900 can receive the data on the telephone line and use an infrared transmitter to convert the data to an infrared signal. An infrared detector coupled to bus 902 can receive the data carried in the infrared signal and place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the worldwide packet data communication network, now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are exemplary forms of carrier waves transporting the information.

Computer system 900 can send messages and receive data, including program code, through the network(s), network link 920, and communication interface 918. In the Internet example, a server 930 might transmit a requested code for an application program through Internet 928, ISP 926, local network 922 and communication interface 918 to download a graphical user interface, as described herein, or messages, data, or information relating thereto. The received code may be executed by processor 904 as it is received, and/or stored in storage device 910, or other non-volatile storage for later execution. In this manner, computer system 900 may obtain application code in the form of a carrier wave.

The appended claims reflect certain aspects and combinations of the present concepts, but are not exhaustive of all such aspects and combinations. Further, the present concepts include all possible logical combinations of the claims and of the various claim elements appended hereto, without limitation, within the associated claim sets regardless of the presently indicated dependency.

What is claimed:

1. A graphical user interface comprising:
a main screen adapted to display a graphical output from a processor;
data input fields adapted to receive data; and
at least one expandable tile, the expandable tile having a closed state and an open state, the expandable tile causing display data and data input fields obscured by the expandable tile in the closed state to be revealed to a user when the expandable tile is placed in its open state.

2. A method for processing an insurance transaction, comprising the acts of:
providing, for a first computer having a display, a main screen comprising a plurality of links to a corresponding plurality of expandable tiles required to process an insurance transaction for a specified risk, each of said expandable tiles comprising at least one required data entry field requiring data input to process said insurance transaction;
activating a link to access an associated one of said plurality of expandable tiles to cause said expandable tile to expand to an expanded state on the main screen to permit data entry into said required data entry fields;
inputting data into the required data entry fields of the expanded tile; and
repeating said activating and inputting acts for each of said expandable tiles comprising at least one required data entry field requiring data input.

3. A method for processing an insurance transaction in accord with claim 2, further comprising the act of:
providing, in said main screen, a summary of said required data entry fields in at least one of said expandable tiles.

4. A method for processing an insurance transaction in accord with claim 3, further comprising the act of:
collapsing an expanded tile subsequent to an input of data into each required data entry field in said expanded tile.

5. A method for processing an insurance transaction in accord with claim 4, wherein said collapsing of said expanded tile occurs automatically upon completion of data input into each of said required data entry fields in said act of inputting.

6. A method for processing an insurance transaction in accord with claim 2, further comprising, subsequent to said act of collapsing:
determining an insurance premium for said risk in view of said input data.

7. A method for processing an insurance transaction in accord with claim 2, further comprising the act of:
outputting from said first computer to a communication interface at least one carrier wave comprising data associated with said plurality of required data entry fields;
communicating said at least one carrier wave to a second computer connected to said communication interface;
displaying a message on said display associated with said first computer confirming the communication of said data associated with said plurality of required data entry fields; and
authorizing an issuance of an insurance policy covering said risk in accord with said communication of said data associated with said plurality of required data entry fields.

8. A method for processing an insurance transaction in accord with claim 7, wherein said act of authorizing is contingent upon the acts of:
accessing an insurance claim history from a database of insurance claim histories; and
verifying at least some of said data associated with said plurality of required data entry fields.

9. A method for processing an insurance transaction in accord with claim 7, wherein said authorizing is provided in response to data borne by said carrier wave comprising a request for an unsupported transaction.

10. A method for processing an insurance transaction in accord with claim 7, wherein said authorizing comprises outputting an authorization signal from said second computer to said first computer through said communication interface.

11. A method for processing an insurance transaction, comprising the acts of:
accessing an existing insurance policy for a first risk type, said existing insurance policy comprising a plurality of first required data entry fields appropriate to said first risk type;
initiating a quotation transaction for a second risk type for an insured of said existing insurance policy, said quotation transaction requiring entry of data into a plurality of second required data entry fields appropriate to said second risk type; and
importing into said quotation transaction data from those of said first required data entry fields which correspond to said second required data entry fields.

12. A computer-readable medium bearing instructions for processing an insurance transaction, said instructions arranged, when executed by one or more processors, to cause the one or more processors to perform the acts of:
providing, for a first computer having a display, a main screen comprising a plurality of links to a corresponding plurality of expandable tiles required to process an insurance transaction for a specified risk, each of said expandable tiles comprising at least one required data entry field requiring data input to process said insurance transaction;
activating a link to access an associated one of said plurality of expandable tiles to cause said expandable tile to expand to an expanded state on the main screen to permit data entry into said required data entry fields; and
inputting data into the required data entry fields of the expanded tile.

13. A computer-readable medium bearing instructions for processing an insurance transaction in accord with claim 12, said instructions arranged, when executed by one or more processors, to cause the one or more processors to further perform the act of:
repeating said activating and inputting acts for each of said expandable tiles comprising at least one required data entry field requiring data input.

14. A computer-readable medium bearing instructions for processing an insurance transaction in accord with claim 13, said instructions arranged, when executed by one or more processors, to cause the one or more processors to further perform the act of:
providing, in said main screen, a summary of said required data entry fields associated with each of said expandable tiles.

15. A computer-readable medium bearing instructions for processing an insurance transaction in accord with claim 14, said instructions arranged, when executed by one or more processors, to cause the one or more processors to further perform the act of:
collapsing an expandable tile subsequent to an input of data into each required data entry field in said expandable tile.

16. A computer-readable medium bearing instructions for processing an insurance transaction in accord with claim 15, wherein said collapsing of said expandable tile occurs automatically upon completion of data input into each of said required data entry fields in said act of inputting.

17. A computer-readable medium bearing instructions for processing an insurance transaction in accord with claim 13, said instructions arranged, when executed by one or more processors, to cause the one or more processors to further perform, subsequent to said act of collapsing, the act of:
determining an insurance premium for said risk in view of said input data.

18. A computer-readable medium bearing instructions for processing an insurance transaction in accord with claim 13, said instructions arranged, when executed by one or more processors, to cause the one or more processors to further perform the acts of:
outputting from said first computer to a communication interface at least one carrier wave comprising data associated with said plurality of required data entry fields;
communicating said at least one carrier wave to a second computer connected to said communication interface;
displaying a message on said display associated with said first computer confirming the communication of said data associated with said plurality of required data entry fields; and
authorizing an issuance of an insurance policy covering said risk in accord with said communication of said data associated with said plurality of required data entry fields.

19. A computer-readable medium bearing instructions for processing an insurance transaction in accord with claim 18, said instructions arranged, when executed by one or more processors, to cause the one or more processors to further perform said act of authorizing contingent upon the acts of:
accessing an insurance claim history from a database of insurance claim histories; and
verifying at least some of said data associated with said plurality of required data entry fields.

20. A computer-readable medium bearing instructions for processing an insurance transaction in accord with claim 18, wherein said authorizing is provided in response to data borne by said carrier wave comprising a request for an unsupported transaction.

21. A computer-readable medium bearing instructions for processing an insurance transaction in accord with claim 18, wherein said authorizing comprises outputting an authorization signal from said second computer to said first computer through said communication interface.

22. An apparatus for processing an insurance transaction, comprising:
a first computer having a display; and
a communication interface connected to said first computer,
wherein said first computer includes an insurance application comprising instructions for processing an insurance transaction, said instructions arranged, when executed by said computer, to perform the acts of
providing a main screen comprising a plurality of links to a corresponding plurality of expandable tiles required to process an insurance transaction for a specified risk, each of said expandable tiles having at least one required data entry field requiring input of data therein to process said insurance transaction and being configured to assume at least a first collapsed state, said first collapsed state being a default state, and a second expanded state;
activating each of said plurality of links to access associated ones of said plurality of expandable tiles to expand said expandable tiles to permit data entry into each of said required data entry fields; and
inputting data corresponding to the required data entry fields.

23. An apparatus for processing an insurance transaction according to claim 22, wherein insurance application comprises instructions for processing an insurance transaction, said instructions arranged, when executed by said computer, to perform the act of determining an insurance premium for said risk in view of said input data.

24. A method for processing an insurance transaction, comprising the acts of:
providing, for a first computer having a display, a main screen comprising a link to at least one expandable tile required to process an insurance transaction for a specified risk, said at least one expandable tile comprising a plurality of required data entry fields requiring input of data therein to process said insurance transaction;
activating said link to expand said at least one expandable tile to an expanded state to permit data entry into said plurality of required data entry fields;
inputting data corresponding to the required data entry fields required to process said insurance transaction in said at least one expandable tile; and
determining an insurance premium for said risk in view of said input data.

25. A method for processing an insurance transaction in accord with claim 24, further comprising the act of:
collapsing said at least one expandable tile subsequent to an input of data into each required data entry field in said at least one expandable tile.
